(19) United States
(12) Patent Application Publication
(10) Pub. No.: US 2026/0317538 A1
(43) Pub. Date: Oct. 15, 2026

(54) MOLDED BODY CONTAINING RECYCLED POLYESTER-BASED RESIN

(71) Applicant: KANEKA CORPORATION, Osaka (JP)

(72) Inventor: Kimihide Nishimura, Hyogo (JP)

(73) Assignee: KANEKA CORPORATION, Osaka (JP)

(21) Appl. No.: 19/687,960

(22) Filed: May 26, 2026

Related U.S. Application Data
(63) Continuation of application No. PCT/JP2024/041974, filed on Nov. 27, 2024.

(30) Foreign Application Priority Data
Nov. 27, 2023 (JP) 2023-200080
Nov. 27, 2023 (JP) 2023-200081
Nov. 27, 2023 (JP) 2023-200083

(51) Int. Cl. C08L 67/02; B65D 1/02; C08J 3/12

(52) U.S. Cl. CPC C08L 67/02; B65D 1/0207; C08J 3/126; C08J 2333/12; C08J 2433/12; C08L 2201/08; C08L 2203/10; C08L 2207/20; C08L 2207/53

(57) ABSTRACT

A molded product which contains a recycled polyester-based resin and which has excellent strength and reduced whitening is provided. The molded product is obtained by molding a resin composition containing a recycled polyester-based resin. The molded product has a solution haze of not less than 1.50% and a haze of not more than 7.5%.

### TECHNICAL FIELD

One or more embodiments of the present invention relate to a molded product containing a recycled polyester-based resin.

### BACKGROUND

In recent years, there is a demand for recycling of resin, from the viewpoint of reuse of resources and environmental protection. However, each time a polyester-based resin is recycled, strength of the polyester-based resin deteriorates due to lowering of melt viscosity. As a technique for addressing the above, a technique in which a chain extender (which may also be referred to as “viscosity modifier” or “melt viscosity modifier: MVI”) is added is known (for example, Patent Literatures 1 to 3).

Further, as a technique for increasing the melt viscosity of a polyester-based resin, a technique called solid state polymerization (SSP) is also known (for example, Patent Literature 4).

### PATENT LITERATURE

### [Patent Literature 1]

PCT International Publication No. WO 2004/039887

### [Patent Literature 2]

PCT International Publication No. WO 2004/041934

### [Patent Literature 3]

PCT International Publication No. WO 2007/040041

### [Patent Literature 4]

Japanese Patent Application Publication Tokukai No. 2016-053138

However, from the viewpoint of whitening of a molded product, the conventional technique as described above is not sufficient and has room for further improvement.

### SUMMARY

One or more embodiments of the present invention have been made in view of the above. One or more embodiments of the present invention are to provide a molded product which contains a recycled polyester-based resin and which has excellent strength and reduced whitening.

As a result of conducting diligent studies in order to achieve the above, the inventor of one or more embodiments of the present invention has arrived at one or more embodiments of the present invention.

That is, a molded product in accordance with one or more embodiments of the present invention is a molded product obtained by molding a resin composition containing a recycled polyester-based resin, the molded product having a solution haze of not less than 1.50%, and a haze of not more than 7.5%,
the solution haze of the molded product being a value measured by performing the following (1) and (2) in order:
   (1) obtaining a solution whose concentration of the resin composition is 0.05 g/mL, by dissolving the resin composition in hexafluoro-2-propanol; and
   (2) measuring the solution haze of the solution of the molded product by use of a haze meter which has been zero-adjusted with hexafluoro-2-propanol; and
the haze of the molded product being a value measured by use of the haze meter.

Further, a whitening inhibitor for a polyester-based resin in accordance with one or more embodiments of the present invention contains a polymer (A) obtained by polymerizing a monomer mixture (A) containing 10% by weight to 60% by weight of an epoxy group-containing monomer (a) and 40% by weight to 90% by weight of an epoxy group-free monomer (b).

Further, a method in accordance with one or more embodiments of the present invention is a method for producing a molded product including the steps of: preparing a recycled polyester-based resin composition; and molding the recycled polyester-based resin composition, the step of preparing the recycled polyester-based resin composition including the steps of: preparing pellets including a polyester-based resin and a whitening inhibitor for a polyester-based resin by melting and kneading the polyester-based resin and the whitening inhibitor for a polyester-based resin; and carrying out solid state polymerization using the pellets, the whitening inhibitor for a polyester-based resin containing a polymer (A) obtained by polymerizing a monomer mixture (A) containing 10% by weight to 60% by weight of an epoxy group-containing monomer (a), and 40% by weight to 90% by weight of an epoxy group-free monomer (b).

One or more embodiments of the present invention make it possible to provide a molded product which contains a recycled polyester-based resin and which has excellent strength and reduced whitening.

### DETAILED DESCRIPTION

The following description will discuss one or more embodiments of the present invention. The present invention is not, however, limited to these embodiments. The present invention is not limited to configurations described below, but may be altered in various ways within the scope of the claims. The present invention also encompasses, in its technical scope, any embodiment or example derived by combining technical means disclosed in differing embodiments and Examples. Further, it is possible to form a new technical feature by combining the technical means disclosed in the respective embodiments. Note that all academic and patent documents cited in the present specification are incorporated herein by reference. Furthermore, any numerical range expressed as “A to B” herein means “not less than A and not more than B (i.e., a range from A to B which includes both A and B)!” unless otherwise stated.

### [1. Molded Product]

A molded product in accordance with one or more embodiments of the present invention is a molded product obtained by molding a resin composition containing a recycled polyester-based resin, the molded product having a solution haze of not less than 1.50%, and a haze of not more than 7.5%,
the solution haze of the molded product being a value measured by performing the following (1) and (2) in order:
   (1) obtaining a solution whose concentration of the resin composition is 0.05 g/mL, by dissolving the resin composition in hexafluoro-2-propanol; and
   (2) measuring the solution haze of the solution of the molded product by use of a haze meter which has been zero-adjusted with hexafluoro-2-propanol; and
the haze of the molded product being a value measured by use of the haze meter.

In the present specification, the “molded product in accordance with one or more embodiments of the present invention” may be referred to as “the present molded product”. In the present specification, the “resin composition containing a recycled polyester-based resin composition” may be referred to as “recycled polyester-based resin composition” or simply as “resin composition”. The resin composition which is used as a raw material for the present molded product can also be said to be a resin composition in accordance with one or more embodiments of the present invention. In the present specification, the “resin composition in accordance with one or more embodiments of the present invention” may be referred to as “the present resin composition”.

The present molded product has advantages of having excellent strength and reduced whitening.

The present molded product contains a recycled polyester-based resin. Therefore, one or more embodiments of the present invention can significantly reduce an amount of plastic waste generated and an amount of plastic used for production. Thus, one or more embodiments of the present invention can contribute to the achievement of Sustainable Development Goals (SDGs) such as Goal 12 “Ensure sustainable consumption and production patterns”.

### [1-1. Resin Composition]

The present molded product is obtained by molding a resin composition containing a recycled polyester-based resin. The present molded product can also be said to be a “resin composition containing a recycled polyester-based resin”.

### (1-1-1. Recycled Polyester-Based Resin)

In the present specification, the “recycled polyester-based resin” may refer to a polyester-based resin which is obtained by recycling, for example, the following (i) and/or (ii):
(i) a polyester-based resin composition and/or a molded product that has been once made as a product in the form of a polyester-based resin composition and/or a molded product, and used and/or discarded; and/or
(ii) a waste polyester-based resin composition and/or a waste molded product which has been discharged in a production process of a polyester-based resin composition and/or a molded product.

On the other hand, a polyester-based resin that has never been made into a product may be referred to as a “virgin polyester-based resin” in the present specification. The “recycled polyester-based resin” in the present specification also includes a mixture obtained by mixing a recycled polyester-based resin with a “virgin polyester-based resin”.

In the present specification, a “resin X obtained by recycling” may be referred to as a “recycled [resin X]”.

A method for recycling the polyester-based resin is not particularly limited, and a known method, such as chemical recycling, material recycling, or thermal recycling, can be used.

The polyester-based resin may be an aromatic polyester having a structure in which an aromatic dicarboxylic acid or an ester derivative component thereof and a diol component such as an aliphatic diol or an alicyclic diol are linked by an ester reaction. This polyester-based resin may be obtained by polycondensing, by a known method, an aromatic dicarboxylic acid or an ester derivative component thereof and a diol component such as an aliphatic diol or an alicyclic diol.

The aromatic dicarboxylic acid is not particularly limited, and examples of the aromatic dicarboxylic acid include phthalic acid, terephthalic acid, isophthalic acid, orthophthalic acid, 1,5-naphthalenedicarboxylic acid, 2,5-naphthalenedicarboxylic acid, 2,6-naphthalenedicarboxylic acid, 2,2′-biphenyldicarboxylic acid, 3,3′-biphenyldicarboxylic acid, 4,4′-biphenyldicarboxylic acid, 4,4′-diphenyl ether carboxylic acid, 4,4′-diphenyl ether dicarboxylic acid, 4,4′-diphenylmethanedicarboxylic acid, 4,4′-diphenylsulfonedicarboxylic acid, 4,4′-diphenylisopropylidenedicarboxylic acid, 1,2-bis(phenoxy)ethane-4,4′-dicarboxylic acid, bis(4,4-carboxyphenyl)methane, anthracenedicarboxylic acid (for example, 2,5-anthracenedicarboxylic acid and 2,6-anthracenedicarboxylic acid), 4,4′-p-terphenylenedicarboxylic acid, and 2,5-pyridinedicarboxylic acid. As the aromatic dicarboxylic acid, only one type may be used, or two or more types may be used in combination.

The aliphatic diol is not particularly limited, and examples of the aliphatic diol include ethylene glycol, propylene glycol, butylene glycol, hexylene glycol, neopentyl glycol, 2-methyl-1,3-propanediol, diethylene glycol, triethylene glycol, 1,5-pentanediol, 1,6-hexanediol, decamethylene glycol, bisphenol A ethylene oxide adduct diol, polyethylene oxide glycol, and polypropylene oxide glycol. Examples of the alicyclic diol include 1,4-cyclohexanedimethanol, 4,4-dicyclohexylhydroxymethane, and 4,4′-dicyclohexylhydroxypropane. As the diol component, only one type may be used, or two or more types may be used in combination.

The polyester-based resin may be a polymer which is formed by copolymerizing: (i) an aromatic dicarboxylic acid or an ester derivative component of the aromatic dicarboxylic acid, which is a main component; (ii) an aliphatic diol; and (iii) another dicarboxylic acid, an ester derivative component of the another dicarboxylic acid, or another diol. Examples of the another dicarboxylic acid include alicyclic dicarboxylic acids such as 1,4-cyclohexanedicarboxylic acid and 4,4′-dicyclohexyldicarboxylic acid.

The polyester-based resin may have a structural component which is derived from a trifunctional or higher functional monomer such as glycerin, trimethylolpropane, pentaerythritol, trimellitic acid, and pyromellitic acid.

Specific examples of the recycled polyester-based resin are not particularly limited, and examples of the recycled polyester-based resin include recycled [polyethylene terephthalate], recycled [polypropylene terephthalate], recycled [polybutylene terephthalate], recycled [polyethylene-2,6-naphthalate], recycled [polybutylene naphthalate], recycled [poly-1,4-cyclohexylenedimethylene terephthalate], recycled [polyethylene-1,2-bis(phenoxy)ethane-4,4′-dicarboxylate], recycled [polyethylene isophthalate/terephthalate], recycled [polybutylene terephthalate/isophthalate], recycled [polybutylene terephthalate/decanedicarboxylate], recycled [polycyclohexanedimethylene terephthalate/isophthalate], recycled [polyester/polyether], and recycled [glycol-modified polyethylene terephthalate]. The glycol-modified polyethylene terephthalate refers to a copolymer of terephthalic acid, ethylene glycol, and a glycol component other than ethylene glycol.

From the viewpoint of moldability and mechanical properties, the polyester-based resin (i) may contain one or more selected from the group consisting of recycled [polypropylene terephthalate], recycled [polybutylene terephthalate], recycled [polyethylene-2,6-naphthalate], recycled [polybutylene naphthalate], recycled [poly-1,4-cyclohexylenedimethylene terephthalate], and recycled [polyester/polyether] and may be composed only of one or more selected from the group, or (ii) may contain one or more selected from the group consisting of recycled [polyethylene terephthalate] and recycled [polybutylene terephthalate] and may be composed only of one or more selected from the group.

As the recycled polyester-based resin, a recycled [polymer alloy] which has been obtained by recycling a polymer alloy obtained from a mixture of multiple types of polymers including a polyester-based resin may be used. Examples of the recycled [polymer alloy] include recycled [polycarbonate/polyethylene terephthalate], recycled [polyethylene terephthalate/glycol-modified polyethylene terephthalate], and recycled [polyethylene terephthalate/copolymerized polyethylene terephthalate]. In other words, the recycled polyester-based resin may contain one or more selected from the group consisting of recycled [polycarbonate/polyethylene terephthalate], recycled [polyethylene terephthalate/glycol-modified polyethylene terephthalate], and recycled [polyethylene terephthalate/copolymerized polyethylene terephthalate], and may be composed only of one or more selected from the group. This configuration has an advantage in that it is possible to easily obtain the recycled polyester-based resin.

Note that the copolymerized polyethylene terephthalate means a resin in which a component (third component) other than the components (two components) constituting polyethylene terephthalate is copolymerized.

### (1-1-2. Whitening Inhibitor)

The present molded product may be molded with use of a whitening inhibitor. In other words, the resin composition may contain a whitening inhibitor. By molding using a whitening inhibitor, (i) the resin composition can have an improved melt viscosity and the molded product composed of the resin composition can have increased strength, and (ii) whitening of the molded product containing the recycled polyester-based resin can be suppressed.

The whitening inhibitor is not particularly limited. As the whitening inhibitor, for example, a whitening inhibitor that is for a polyester-based resin and that has the following configuration is suitably used: a whitening inhibitor for a polyester-based resin, the whitening inhibitor containing a polymer (A) obtained by polymerizing a monomer mixture (A) containing (a) 10% by weight to 60% by weight of an epoxy group-containing alkyl (meth)acrylate, and (b) 40% by weight to 90% by weight of an epoxy group-free alkyl (meth)acrylate.

As the whitening inhibitor, for example, the whitening inhibitor for a polyester-based resin in accordance with one or more embodiments of the present invention described in the section [2. Whitening inhibitor] below, such as a whitening inhibitor for a polyester-based resin which has the following configuration, is also suitably used: a whitening inhibitor for a polyester-based resin, the whitening inhibitor containing a polymer (A) obtained by polymerizing a monomer mixture (A) containing 10% by weight to 60% by weight of an epoxy group-containing monomer (a), and 40% by weight to 90% by weight of an epoxy group-free monomer (b).

### (Copolymer (A))

In the present specification, the “epoxy group-containing monomer (a)” may be referred to as “component (a)”, and the “epoxy group-free monomer (b)” may be referred to as “component (b)”.

In the present specification, the “epoxy group-containing monomer (a)” means a monomer containing an epoxy group.

An epoxy group has favorable reactivity with a terminal functional group of a recycled polyester-based resin. Therefore, the whitening inhibitor may contain the epoxy group-containing monomer (a).

The following description will discuss a case where the resin composition contains a whitening inhibitor. In this case, in a production process of the resin composition containing a recycled polyester-based resin and a whitening inhibitor (for example, during melting and kneading of the recycled polyester-based resin and the whitening inhibitor), a reactive functional group (for example, epoxy group) in the polymer (A) contained in the whitening inhibitor can react with a terminal functional group (for example, hydroxyl group or carboxyl group) of the recycled polyester-based resin. Due to this reaction, the recycled polyester-based resin can have an extended molecular chain; due to this mechanism, the melt viscosity of the resin composition is improved, and the strength of the molded product is improved. Further, since the whitening inhibitor contains the above-described polymer (A), dispersibility of the whitening inhibitor in the resin composition can be improved. It is inferred that this suppresses whitening of the molded product. Note that one or more embodiments of the present invention are not limited by such mechanism and inference at all.

The epoxy group-containing monomer (a) is not particularly limited. In one or more embodiments of the present invention, the epoxy group-containing monomer may be an epoxy group-containing alkyl (meth)acrylate. The following description will focus on the epoxy group-containing alkyl (meth)acrylate as the component (a).

Examples of the component (a) include glycidyl acrylate, glycidyl methacrylate, 4-hydroxybutyl acrylate glycidyl ether, 3,4-epoxycyclohexyl (meth)acrylate, allyl glycidyl ether, and β-methylglycidyl (meth)acrylate, but the component (a) is not particularly limited. As the component (a), only one type may be used, or two or more types may be used in combination.

From the viewpoint of polymerization productivity, the component (a) (i) may contain one or more selected from the group consisting of glycidyl acrylate, glycidyl methacrylate, 4-hydroxybutyl acrylate glycidyl ether, 3,4-epoxycyclohexyl (meth)acrylate, and β-methylglycidyl (meth)acrylate and may be composed only of one or more selected from the group, (ii) may contain one or more selected from the group consisting of glycidyl acrylate, glycidyl methacrylate, 4-hydroxybutyl acrylate glycidyl ether, and 3,4-epoxycyclohexyl (meth)acrylate and may be composed only of one or more selected from the group, (iii) may contain one or more selected from the group consisting of glycidyl acrylate, glycidyl methacrylate, and 4-hydroxybutyl acrylate glycidyl ether and may be composed only of one or more selected from the group, (iv) may contain one or more selected from the group consisting of glycidyl acrylate and glycidyl methacrylate and may be composed only of one or more selected from the group, or (v) may contain glycidyl methacrylate and may be composed only of glycidyl methacrylate.

The content of the component (a) in the monomer mixture (A) is not particularly limited, but may be 10% by weight to 60% by weight with respect to 100% by weight of the monomer mixture (A). The upper limit of the content may be 55% by weight, 50% by weight, 45% by weight, or 40% by weight, and the lower limit of the content may be 15% by weight, 20% by weight, 25% by weight, or 30% by weight. In a case where the content of the component (a) is within the above range, the effect of improving the melt viscosity of the resin composition can be favorable. This leads to having an advantage in that the molded product has more excellent moldability and more excellent strength. In the present specification, “the molded product having excellent moldability” means that the molded product has more uniform wall thickness distribution.

In the present specification, the “epoxy group-free monomer (b)” means a monomer other than the “epoxy group-containing monomer (a)”, that is, a monomer that does not contain an epoxy group.

The component (b) may be an alkyl (meth)acrylate having no reactive functional group (for example, an epoxy group-free alkyl (meth)acrylate). Specific examples of the alkyl (meth)acrylate having no reactive functional group include alkyl (meth)acrylates having an alkyl group having 1 to 22 carbon atoms, such as methyl (meth)acrylate, ethyl (meth)acrylate, propyl (meth)acrylate, butyl (meth)acrylate, 2-ethylhexyl (meth)acrylate, octyl (meth)acrylate, dodecyl (meth)acrylate, stearyl (meth)acrylate, and behenyl (meth)acrylate.

As the component (b), only one type of the above-described monomers may be used, or two or more types may be used in combination.

The number of carbon atoms of the alkyl group in the component (b) is not particularly limited, but may be not more than 22 from the viewpoint of polymerizability. Further, from the viewpoint of compatibility with the recycled polyester-based resin, the number of carbon atoms of the alkyl group in the component (b) may be not more than 12, not more than 8, or may be 1 to 4.

From the viewpoint of the dispersibility of the whitening inhibitor, the component (b) (i) may contain one or more selected from the group consisting of epoxy group-free alkyl methacrylates and may be composed only of one or more selected from the group, (ii) may contain one or more selected from the group consisting of methyl methacrylate, ethyl methacrylate, propyl methacrylate, and butyl methacrylate and may be composed only of one or more selected from the group, (iii) may contain one or more selected from the group consisting of methyl methacrylate and butyl methacrylate and may be composed only of one or more selected from the group, or (iv) may contain methyl methacrylate and may be composed only of methyl methacrylate.

The content of the component (b) in the monomer mixture (A) is not particularly limited, but may be 40% by weight to 90% by weight with respect to 100% by weight of the monomer mixture (A). The upper limit of the content may be 85% by weight, 80% by weight, 75% by weight, or 70% by weight, and the lower limit of the content may be 45% by weight, 50% by weight, 55% by weight, or 60% by weight. In a case where the content of the component (b) is within the above range, there is an advantage in that the dispersibility of the whitening inhibitor in the resin composition can be improved. This can lead to also having an advantage in that whitening of the molded product obtained is further suppressed.

The monomer mixture (A) may further contain a vinyl monomer (c) other than the component (a) and the component (b), which is copolymerizable with the component (a) and the component (b). In the present specification, the “vinyl monomer (c) other than the component (a) and the component (b), the vinyl monomer (c) being copolymerizable with the component (a) and the component (b)” may be referred to as “component (c)”.

Examples of the component (c) include one or more selected from the group consisting of a vinyl cyanide compound, an aromatic vinyl compound, and (meth)acrylic acid, but the component (c) is not particularly limited.

Examples of the vinyl cyanide compound include acrylonitrile and methacrylonitrile.

The aromatic vinyl compound is not particularly limited, and examples of the aromatic vinyl compound include styrene, vinyltoluene, α-methylstyrene, 4-methylstyrene, 3-methylstyrene, 4-methoxystyrene, 4-ethylstyrene, 4-ethoxystyrene, 3,4-dimethylstyrene, 2-chlorostyrene, 3-chlorostyrene, 4-chloro-3-methylstyrene, 3-(tert-butyl)styrene, 2,4-dichlorostyrene, 2,6-dichlorostyrene, and 1-vinylnaphthalene.

As the component (c), only one type of the above-described monomers may be used, or two or more types may be used in combination.

From the viewpoint of polymerization productivity, the component (c) (i) may contain one or more selected from the group consisting of 4-methylstyrene, 3-methylstyrene, α-methylstyrene, and styrene and may be composed only of one or more selected from the group, (ii) may contain one or more selected from the group consisting of 4-methylstyrene, α-methylstyrene, and styrene and may be composed only of one or more selected from the group, (iii) may contain one or more selected from the group consisting of α-methylstyrene and styrene and may be composed only of one or more selected from the group, or (iv) may contain styrene and may be composed only of styrene.

On the other hand, a lower content of the aromatic vinyl compound (particularly styrene) in the monomer mixture (A) is more preferable since a molded product having further reduced whitening can be provided. With respect to 100% by weight of the monomer mixture (A), the content of the aromatic vinyl compound may be not more than 10% by weight, not more than 5% by weight, not more than 3% by weight, or not more than 1% by weight. With respect to 100% by weight of the monomer mixture (A), the content of the aromatic vinyl compound may be 0% by weight, that is, the monomer mixture (A) may contain no aromatic vinyl compound. The content of styrene may be not more than 10% by weight, not more than 5% by weight, not more than 3% by weight, or not more than 1% by weight with respect to 100% by weight of the monomer mixture (A), since a molded product having further reduced whitening can be provided. With respect to 100% by weight of the monomer mixture (A), the content of styrene may be 0% by weight, that is, the monomer mixture (A) may contain no styrene.

The content of the component (c) in the monomer mixture (A) is not particularly limited, but may be 0% by weight to 10% by weight with respect to 100% by weight of the monomer mixture (A). The upper limit of the content may be 8% by weight or 5% by weight, and the lower limit of the content may be 2% by weight or 4% by weight. In a case where the content of the component (c) is within the above range, there is an advantage in that productivity is improved.

From the viewpoint of (i) balance between thermal stability and productivity of the whitening inhibitor and (ii) improvement of the melt viscosity of the resin composition, the number average molecular weight of the polymer (A) may be in the range of 2,000 to 6,000. The lower limit of the number average molecular weight of the polymer (A) may be not less than 3,000, or may be not less than 4,000. Further, the upper limit of the number average molecular weight of the polymer (A) may be not more than 5,500, not more than 5,000, not more than 4,500, not more than 4,000, or not more than 3,500. The number average molecular weight of the polymer (A) can be adjusted with use of a chain transfer agent during polymerization for producing the polymer (A). In other words, in order to obtain the polymer (A) having a number average molecular weight within the above-mentioned range, it is preferable to use a chain transfer agent during the polymerization for producing the polymer (A). Note that the number average molecular weight of the polymer (A) can be measured by gel permeation chromatography (GPC) and determined as a polystyrene equivalent molecular weight. A method of measuring the number average molecular weight of the polymer (A) will be described in detail in Examples later.

The polymer (A) may have 2 to 15 reactive functional groups on average per molecule of the polymer (A). The lower limit of the number of the reactive functional groups may be not less than 3. The upper limit of the number of the reactive functional groups may be not more than 13, not more than 11, not more than 9, or not more than 8. In a case where the number of reactive functional groups in the polymer (A) is within the above range, the melt viscosity of the resin composition can be suitably improved without causing gelation and without impairing mechanical properties, heat resistance, rheological properties, etc. of the molded product.

The polymer (A) may be a non-rubbery polymer. The non-rubbery polymer refers to a polymer having no cross-linked structure between molecular chains of the polymer. Since the polymer (A) is a non-rubbery polymer, there are advantages in that: the reaction between the reactive functional group (for example, epoxy group) of the polymer (A) and the terminal functional group of the recycled polyester-based resin proceeds more efficiently; and the melt viscosity of the resin composition is easily improved.

### (Method for Producing Polymer (A))

As a polymerization method for obtaining the polymer (A), a known method can be used and is not particularly limited. For example, bulk polymerization, solution polymerization, suspension polymerization, or emulsion polymerization can be employed, but emulsion polymerization is preferable.

The polymer (A) may be a polymer obtained by emulsion polymerization. In other words, in production of the whitening inhibitor, it is preferable to include a step of obtaining the polymer (A) by emulsion polymerization. In the present specification, “emulsion polymerization” means carrying out a polymerization reaction in the presence of an emulsifier, which will be described later. Further, during the emulsion polymerization, the emulsifier may react to generate a salt which is derived from the emulsifier. Therefore, in a case where the polymer (A) is a polymer which is obtained by emulsion polymerization, the polymer (A) may contain an emulsifier which will be described later and/or a salt which is derived from the emulsifier. In other words, a polymer containing an emulsifier which will be described later and/or a salt which is derived from the emulsifier can also be regarded as a polymer which is obtained by emulsion polymerization.

During production of the polymer (A), it is preferable to carry out polymerization in the presence of a chain transfer agent in order to control the molecular weight. In other words, the monomer mixture (A) may contain a chain transfer agent.

Examples of the chain transfer agent include, but are not particularly limited to: primary mercaptan-based chain transfer agents such as n-butyl mercaptan, n-octyl mercaptan, n-hexadecyl mercaptan, n-dodecyl mercaptan, and n-tetradecyl mercaptan; secondary mercaptan-based chain transfer agents such as sec-butyl mercaptan and sec-dodecyl mercaptan; tertiary mercaptan-based chain transfer agents such as t-dodecyl mercaptan; mercaptan compounds; thioglycolic acid esters such as 2-ethylhexyl thioglycolate, ethylene glycol dithioglycolate, trimethylolpropane tris(thioglycolate), and pentaerythritol tetrakis(thioglycolate); thiophenol; tetraethylthiuram disulfide; pentanephenylethane; acrolein; methacrolein; allyl alcohol; carbon tetrachloride; ethylene bromide; styrene oligomers such as α-methylstyrene dimer; and terpinolene. One type of chain transfer agents may be used alone or two or more types may be used in combination. The amount of the chain transfer agent used may be set, as appropriate, in accordance with a desired number average molecular weight of the polymer (A).

Examples of the emulsifier (dispersant) which can be used in emulsion polymerization include, but are not particularly limited to, anionic surfactants, nonionic surfactants, cationic surfactants, amphoteric surfactants, and the like. Further, a dispersant such as polyvinyl alcohol, alkyl-substituted cellulose, polyvinyl pyrrolidone, and/or a polyacrylic acid derivative may be used. One type of these emulsifiers (dispersants) may be used alone or two or more types may be used in combination.

In a case where an emulsion polymerization method is employed, a pyrolytic initiator can be used as a radical polymerization initiator. Examples of the pyrolytic initiator include known initiators such as 2,2′-azobisisobutyronitrile, hydrogen peroxide, potassium persulfate, and ammonium persulfate.

A redox initiator can also be used as the radical polymerization initiator. The redox initiator is an initiator that contains a combination of (a) a peroxide(s) such as an organic peroxide and/or an inorganic peroxide and (b) a reducing agent(s) such as sodium formaldehyde sulfoxylate and/or glucose as necessary, a transition metal salt such as iron (II) sulfate as necessary, a chelating agent such as disodium ethylenediaminetetraacetate as necessary, and/or a phosphorus-containing compound such as sodium pyrophosphate as necessary. Examples of the organic peroxide include t-butylperoxy isopropyl carbonate, paramenthane hydroperoxide, cumene hydroperoxide, dicumyl peroxide, t-butyl hydroperoxide, di-t-butyl peroxide, and t-hexyl peroxide. Examples of the inorganic peroxide include hydrogen peroxide, potassium persulfate, and ammonium persulfate.

Using a redox-type initiator makes it possible to (i) carry out polymerization even at a low temperature at which pyrolysis of the peroxide substantially does not occur, and (ii) select the polymerization temperature from a wide range of temperatures. Therefore, it is preferable to use a redox initiator. Among redox initiators, a redox type initiator using, as a peroxide, an organic peroxide such as cumene hydroperoxide, dicumyl peroxide, paramenthane hydroperoxide, and t-butyl hydroperoxide is preferable. The amount of the initiator used can be within a known range. In a case where a redox initiator is used, the amounts of e.g. the reducing agent, the transition metal salt, and the chelating agent used can be each within a known range.

In the polymerization for producing the polymer (A), a known surfactant can also be used.

In a case where the polymer (A) is produced by emulsion polymerization, a latex (for example, aqueous latex) containing the polymer (A) can be obtained. By separating the polymer (A) from the latex containing the polymer (A), the polymer (A) can be obtained. The polymer (A) thus obtained can be used as the whitening inhibitor. A method of separating the polymer (A) from the latex containing the polymer (A) is not particularly limited, and examples of the method include salting out of the polymer (A) using an acid, a metal salt, and the like, and precipitation of the polymer (A) using an organic solvent. The polymer (A) separated from the latex containing the polymer (A) may be cleaned and further dried. By separating the polymer (A) from the latex containing the polymer (A), and subjecting the polymer (A) to cleaning and further to drying, a powder of the polymer (A) (also referred to as “powder”) can be obtained. Also, by spray-drying the latex containing the polymer (A), the powder of the polymer (A) can be obtained. The powder of the polymer (A) thus obtained can be used as the whitening inhibitor.

### (Polymer (B))

The whitening inhibitor may or may not contain a polymer (B) in addition to the polymer (A). In the whitening inhibitor, a polymer component may be composed only of the polymer (A), may be composed only of the polymer (A) and the polymer (B), or may be composed of the polymer (A), the polymer (B), and a polymer in addition to the polymer (A), the polymer (B).

The following description will discuss a case where the whitening inhibitor contains the polymer (A) and the polymer (B) (hereinafter, also referred to as “Case A”). In Case A, it is preferable to polymerize the polymer (B) in the presence of the polymer (A) after polymerizing the polymer (A). In Case A, in a case where the polymer (A) is obtained by, for example, emulsion polymerization, it is particularly preferable to carry out production (polymerization) of the polymer (B) in the latex containing the polymer (A) after production (polymerization) of the polymer (A). In a case where the production (polymerization) of the polymer (B) is carried out in the latex containing the polymer (A), a composite consisting of the polymer (A) and the polymer (B) (or including the polymer (A) and the polymer (B)) can be obtained. In the composite, the polymer (B) can cover a part of the polymer (A). Therefore, in the composite, the polymer (A) can be referred to as a core portion, and the polymer (B) can be referred to as a shell portion. The composite may have a core-shell structure which has the polymer (A) as the core portion and the polymer (B) as the shell portion. In other words, in a case where the production (polymerization) of the polymer (B) is carried out in the latex containing the polymer (A), it is possible to obtain a composite which consists of the polymer (A) and the polymer (B) and in which the polymer (A) forms the core portion and the polymer (B) forms the shell portion, that is, a composite having a core-shell structure. In the composite, the polymer (B) may entirely cover the polymer (A), or the interior of the polymer (A) that is in particle form may be impregnated with the polymer (B).

In a case where the whitening inhibitor contains the polymer (A) and the polymer (B) and the composite consisting of the polymer (A) and the polymer (B) has a core-shell structure in which the polymer (A) forms a core portion and the polymer (B) forms a shell portion, there is an advantage in that productivity is improved.

The polymer (B) is not particularly limited. Composition of a structural unit of the polymer (B) may be the same as or different from composition of a structural unit of the polymer (A). In other words, composition of a monomer mixture (B) may be the same as or different from composition of the monomer mixture (A).

The polymer (B) may be a polymer which is obtained by polymerizing a monomer mixture (B) containing 10% by weight to 60% by weight of an epoxy group-containing monomer (a), and 40% by weight to 90% by weight of an epoxy group-free monomer (b). The polymer (B) may further contain 0% by weight to 10% by weight of a vinyl monomer (c) other than the component (a) and the component (b), the vinyl monomer (c) being copolymerizable with the component (a) and the component (b).

The number average molecular weight of the polymer (B) may be different from the number average molecular weight of the polymer (A). The number average molecular weight of the polymer (B) may be larger than the number average molecular weight of the polymer (A). According to this configuration, the polymer (composite) has a higher softening point, and a defect such as sticking may be less likely to occur. As a result, there is an advantage in that productivity is improved.

The polymer (B) may be a non-rubbery polymer. According to this configuration, there are advantages in that: a reaction between a reactive functional group of the polymer (B) and the terminal functional group of the recycled polyester-based resin proceeds more efficiently; and the melt viscosity of the resin composition is easily improved. In Case A, (i) the polymer (A) may be a non-rubbery polymer or the polymer (B) may be a non-rubbery polymer, or (ii) both the polymer (A) and the polymer (B) may be non-rubbery polymers (for example, the whole of the composite may be a non-rubbery polymer).

The following description will discuss a case where the whitening inhibitor contains the polymer (A) and the polymer (B) and the composite consisting of the polymer (A) and the polymer (B) has a core-shell structure in which the polymer (A) forms a core portion and the polymer (B) forms a shell portion (hereinafter, also referred to as “Case B”). In both of Case A and Case B, the ratio of the weight of the polymer (A) to the weight of the polymer (B) in the composite (weight of polymer (A)/weight of polymer (B)) is not particularly limited, but may be 20/80 to 80/20, 30/70 to 70/30, 35/65 to 65/35, or 40/60 to 60/40. In a case where the ratio of the weight of the polymer (A) to the weight of the polymer (B) in the composite is within the above range, there is an advantage in that productivity is improved.

In Case B, the number average molecular weight of the polymer (A) is not particularly limited, but may be 2,000 to 5,000, 2,000 to 4,000, 2,500 to 4,000, or 2,500 to 3,500. According to this configuration, there is an advantage in that the balance between improvement in melt viscosity and suppression of whitening is improved. In both of Case A and Case B, the number average molecular weight of the polymer (B) is not particularly limited, but may be 3,000 to 6,000, 3,000 to 5,000, 3,500 to 5,000, or 3,500 to 4,500. According to this configuration, there is an advantage in that productivity is improved.

The polymer (B) may have 2 to 15 reactive functional groups on average per molecule of the polymer (B). The lower limit of the reactive functional groups on average may be not less than 3. The upper limit of the number of the reactive functional groups on average may be not more than 13, not more than 11, or not more than 9. In a case where the number of reactive functional groups in the polymer (B) is within the above range, the melt viscosity of the resin composition can be suitably improved without causing gelation and without impairing the mechanical properties, heat resistance, rheological properties, etc. of the molded product.

The polymer (A) and the polymer (B) may differ in one or more selected from the group consisting of the composition of a structural unit, the number average molecular weight, the average number of reactive functional groups per molecule, and the epoxy equivalent.

### (Method for Producing Polymer (B))

As a polymerization method for obtaining the polymer (B), a known method can be used and is not particularly limited. For example, bulk polymerization, solution polymerization, suspension polymerization, or emulsion polymerization can be employed, but emulsion polymerization is preferable. During production of the polymer (B), it is preferable to carry out polymerization in the presence of a chain transfer agent in order to control the molecular weight. In other words, the monomer mixture (B) may contain a chain transfer agent.

Regarding the polymer (B), for matters other than those described above, the descriptions in the section [Polymer (A)] can apply as appropriate. For example, regarding the types and contents of the component (a), the component (b), and the component (c) which are contained in the monomer mixture (B), one or more embodiments that are preferable for the polymer (A) (monomer mixture (A)) are also preferable for the polymer (B) (monomer mixture (B)).

In the whitening inhibitor, a lower content of a polymer having a molecular weight of not more than 1000 is more preferable. The whitening inhibitor having a lower content of the polymer having a molecular weight of not more than 1000 has an advantage in that the whitening inhibitor can be more suitably used in food applications.

The content of the polymer having a molecular weight of not more than 1000 in the whitening inhibitor is not particularly limited, but may be not more than 4.00% by weight, not more than 3.00% by weight, not more than 2.00% by weight, or not more than 1.00% by weight with respect to 100% by weight of the whitening inhibitor. According to this configuration, there is an advantage in that the whitening inhibitor can be more suitably used in food applications. The lower limit of the content of the polymer having a molecular weight of not more than 1000 in the whitening inhibitor is 0.00% by weight, that is, the whitening inhibitor may not contain a polymer having a molecular weight of not more than 1000.

The whitening inhibitor may have a lower content of a polymer (A) having a molecular weight of not more than 1000. The content of the polymer (A) having a molecular weight of not more than 1000 in the whitening inhibitor is not particularly limited, but may be not more than 4.00% by weight, not more than 3.00% by weight, not more than 2.00% by weight, or not more than 1.00% by weight with respect to 100% by weight of the whitening inhibitor. According to this configuration, there is an advantage in that the whitening inhibitor can be more suitably used in food applications. The lower limit of the content of the polymer (A) having a molecular weight of not more than 1000 in the whitening inhibitor is 0.00% by weight, that is, the whitening inhibitor may not contain the polymer (A) having a molecular weight of not more than 1000.

In Case A, in the whitening inhibitor, a lower content of the polymer (B) having a molecular weight of not more than 1000 is more preferable. In Case A, the content of the polymer (B) having a molecular weight of not more than 1000 in the whitening inhibitor is not particularly limited, but may be not more than 4.00% by weight, not more than 3.00% by weight, not more than 2.00% by weight, or not more than 1.00% by weight with respect to 100% by weight of the whitening inhibitor. According to this configuration, there is an advantage in that the whitening inhibitor can be more suitably used in food applications. In Case A, the lower limit of the content of the polymer (B) having a molecular weight of not more than 1000 in the whitening inhibitor is 0.00% by weight, that is, the whitening inhibitor may not contain the polymer (B) having a molecular weight of not more than 1000.

The content of the whitening inhibitor in the resin composition is not particularly limited. The content of the whitening inhibitor in the resin composition may be 0.1% by weight to 10.0% by weight with respect to 100% by weight of the resin composition. The lower limit of the content may be not less than 0.2% by weight. The upper limit of the content may be not more than 8.0% by weight, not more than 6.0% by weight, or not more than 4.0% by weight. In a case where the content of the whitening inhibitor in the resin composition is within the above range, there is an advantage in that the balance between improvement in melt viscosity and suppression of whitening becomes favorable.

In the resin composition, the recycled polyester-based resin and the whitening inhibitor can react with each other. More specifically, in the resin composition, the reactive functional group (for example, epoxy group) of a reactive functional group-containing unit in the polymer (A) contained in the whitening inhibitor can react with a terminal functional group (for example, hydroxyl group or carboxyl group) of the recycled polyester-based resin. As a result of such a reaction, a resin which has a structural unit derived from the recycled polyester-based resin and a structural unit derived from the whitening inhibitor can be formed. Therefore, in the resin composition, (i) at least a part of the recycled polyester-based resin may react with the whitening inhibitor and exist as a structural unit derived from the recycled polyester-based resin, (ii) at least a part of the whitening inhibitor may react with the recycled polyester-based resin and exist as a structural unit derived from the whitening inhibitor, and (iii) in the structural unit derived from the whitening inhibitor, for example, the epoxy group of the polymer (A) may exist in a state of being covalently bonded to a terminal of the structural unit derived from the recycled polyester-based resin. Note that in the present specification, the expression “a resin composition contains a recycled polyester-based resin and a whitening inhibitor” includes a case where the recycled polyester-based resin and the whitening inhibitor exist as a structural unit derived from the recycled polyester-based resin and a structural unit derived from the whitening inhibitor, respectively, in the resin composition.

### (1-1-3. Other Resins)

The present resin composition may or may not further contain a resin other than the recycled polyester-based resin. The resin other than the recycled polyester-based resin is not particularly limited, and examples of the resin other than the recycled polyester-based resin include virgin polyester-based resin, polyethylene, polypropylene, polyvinyl chloride, polystyrene, polyvinyl acetate, polyurethane, polytetrafluoroethylene, ABS resin, AS resin, acrylic resin, polyacetal, polycarbonate, modified polyphenylene ether, polyamide, and cyclic polyolefin.

The content of the resin other than the recycled polyester-based resin in the present resin composition is not particularly limited, but may be, for example, 0 parts by weight to 60 parts by weight with respect to 100 parts by weight of the recycled polyester-based resin. The upper limit of the content may be not more than 50 parts by weight, not more than 40 parts by weight, not more than 30 parts by weight, not more than 20 parts by weight, not more than 10 parts by weight, not more than 5 parts by weight, or not more than 1 part by weight.

In the present resin composition, the content of the resin other than the polyester-based resin, which include the recycled polyester-based resin and the virgin polyester-based resin, is not particularly limited. In the present resin composition, the content of the resin other than the polyester-based resin with respect to 100 parts by weight of the polyester-based resin, that is, 100 parts by weight of the total amount of the recycled polyester-based resin and the virgin polyester-based resin, may be 0 parts by weight to 60 parts by weight. The upper limit of the content may be not more than 50 parts by weight, not more than 40 parts by weight, not more than 30 parts by weight, not more than 20 parts by weight, not more than 10 parts by weight, not more than 5 parts by weight, or not more than 1 part by weight.

### (1-1-4. Other Additives)

The present molded product may be molded with use of another additive. In other words, the present resin composition may contain another additive. The another additive is not particularly limited, and examples of the other additive include flame retardants, flame retardant auxiliary agents, anti-dripping agents, reinforcing agents, fillers, antioxidants, pigments, dyes, conductivity imparting agents, hydrolysis inhibitors, thickeners, plasticizers, lubricants, ultraviolet absorbers, antistatic agents, fluidity improvers, mold releases, compatibilizers, and thermal stabilizers.

### (1-1-5. Method for Producing Resin Composition)

The method for producing the present resin composition is not particularly limited, and a general method for producing a resin composition can be applied. For example, the resin composition can be obtained by: mixing raw materials (for example, recycled polyester-based resin and whitening inhibitor) by a Henschel mixer, a tumbler mixer, or the like; and then melting and kneading a mixture obtained. For the melting and kneading, a kneader such as a single-screw or twin-screw extruder, a Banbury mixer, a pressure kneader, or a mixing roll can be used. By such melting and kneading, pellets consisting of the resin composition can be produced.

### (1-1-6. Physical Properties of Resin Composition)

A resin composition having a higher melt viscosity (IV value) can provide a molded product that has more excellent strength. In other words, the present resin composition may have a high melt viscosity (IV value). A method of measuring the melt viscosity (IV value) of the resin composition will be described in detail in Examples later.

A resin composition having a lower MFR can provide a molded product that has more excellent strength. In other words, the present resin composition may have a low MFR.

The melt flow rate (MFR) of the resin composition may be 3.7 g/10 min to 30.0 g/10 min, 3.7 g/10 min to 29.5 g/10 min, 3.7 g/10 min to 29.0 g/10 min, 3.7 g/10 min to 28.5 g/10 min, 3.7 g/10 min to 28.0 g/10 min, or 3.7 g/10 min to 27.5 g/10 min. In a case where the melt flow rate (MFR) of the resin composition is within the above range, there is an advantage in that the molded product has excellent strength. A method of measuring the MFR of the resin composition will be described in detail in Examples later.

As a method of improving the melt viscosity (IV value) of a recycled polyester-based resin, a technique called solid state polymerization (SSP) is known. A molded product which is formed by molding a resin composition obtained through solid state polymerization using a recycled polyester-based resin as a raw material has an advantage in that the molded product does not whiten at all or a degree of whitening is very small even if the molded product whitens. However, solid state polymerization requires an enormous amount of energy because the solid state polymerization is carried out under vacuum and at high temperature for a long time. With regard to a haze of a solution obtained by dissolving a molded product obtained from a resin composition which has been obtained through solid state polymerization using a recycled polyester-based resin as a raw material, the haze is, for example, approximately 1.0%. On the other hand, with regard to a haze of a solution obtained by dissolving the molded product obtained from the present resin composition, the haze is, for example, not less than 1.50%. In other words, in a case where the haze of a solution obtained by dissolving a molded product is not less than 1.50%, it can be considered that the molded product is not obtained from a resin composition which has been obtained through solid state polymerization. In one or more embodiments of the present invention, the haze of the solution obtained by dissolving the molded product may be not less than 2.00%, not less than 2.50%, or not less than 3.00%.

### [1-2. Method for Producing Molded Product]

A method for producing a molded product, in other words, a method for molding the resin composition, is not particularly limited. As the method for producing a molded product (method for molding the resin composition), for example, an injection molding method, an extrusion molding method, a blow molding method, a calender molding method, an inflation molding method, a rotational molding method, or a press molding method can be used. Among these, the blow molding method is preferable. In other words, the molded product in accordance with one or more embodiments of the present invention may be a molded product which is formed by blow molding of the present resin composition.

In the present specification, the blow molding method may be a molding method in which only blow molding is carried out using the resin composition, or may be a molding method carried out in combination with another molding method (for example, injection molding method, extrusion molding method, and/or calender molding method). As the molding method carried out in combination with another molding method, a two-step blow molding method is preferable. The two-step blow molding method is a molding method in which, in a first step, an injection-molded product is obtained by injection molding of the resin composition, and then, in a second step, the injection-molded product is subjected to blow molding.

### [1-3. Physical Properties of Molded Product]

The degree of whitening of the molded product can be evaluated by a difference (ΔL) in L value before and after stretching of a film (molded product) which is obtained by molding the resin composition into a film shape. Specifically, the resin composition is molded into a film shape, and a tensile test is performed on the film (molded product) obtained. A smaller difference (ΔL) in L value before and after stretching means that whitening of a molded product obtained from the resin composition is reduced to a greater extent. For example, in blow molding of a resin composition or an injection-molded product, the resin composition or the injection-molded product is molded while being stretched. It can be said that stretching of the film (molded product) in the tensile test simulates stretching during blow molding of the resin composition or the injection-molded product. Therefore, it can be said that in a case where the ΔL of the film (molded product) is smaller, whitening of a blow-molded product (for example, bottle-shaped molded product) obtained by blow molding is reduced to a greater extent.

In one or more embodiments of the present invention, the ΔL may be not more than 9.5, not more than 9.0, not more than 8.0, not more than 7.0, not more than 6.0, or not more than 5.0. The lower limit of the ΔL is not particularly limited and may be 0, may be 1.0, may be 1.5, or may be 2.0. The ΔL in the above range means that whitening of the molded product is suppressed. A method of measuring the ΔL of the film (molded product) will be described in detail in Examples later.

The haze of the present molded product may be not more than 7.5%, not more than 6.5%, not more than 5.5%, not more than 5.0%, not more than 4.5%, or not more than 4.0%. The lower limit of the haze of the molded product is not particularly limited; for example, the haze is 1.0%. The haze of the molded product in the above range means that the molded product has high transparency. A method of measuring the haze of the molded product will be described in detail in Examples later.

The total light transmittance (TT) of the present molded product may be not less than 80.0%, not less than 80.5%, not less than 81.0%, not less than 81.5%, not less than 82.0%, or not less than 82.5%. The upper limit of the total light transmittance (TT) of the molded product is not particularly limited; for example, the upper limit is 100%. The total light transmittance (TT) of the molded product in the above range means that the transparency of the molded product is high. A method of measuring the total light transmittance (TT) of the molded product will be described in detail in Examples later.

The present molded product may have a buckling strength of 200, 250, 300, or 350. In a case where the buckling strength of the molded product is within the above range, there is an advantage in that the molded product can be used in applications in a broader range. A method of measuring the buckling strength of the molded product will be described in detail in Examples later.

### [1-4. Shape of Molded Product]

The shape of the present molded product is not particularly limited. It is possible to obtain molded products of various shapes by the above-described various molding methods using the resin composition. Examples of the shape of the present molded product include a bottle shape, a sheet shape, a film shape, and a rod shape. Among these, the present molded product may have a bottle shape, may have a blow-molded product (molded product) which is obtained by a blow molding method, or a bottle-shaped blow-molded product (bottle-shaped molded product) which is obtained by blow molding.

### [2. Whitening Inhibitor]

One or more embodiments of the present invention provide a whitening inhibitor.

Conventional viscosity modifiers had the following: although the melt viscosity of a resin composition is improved to some extent by mixing a matrix resin (for example, polyester-based resin) and a viscosity modifier, a molded product which is formed by molding the resin composition obtained whitens. Conventionally, in order to address the above, efforts have been made to make the refractive index of the matrix resin and the refractive index of a polymer which is a main component of the viscosity modifier as equal as possible. For example, in a case where the matrix resin was a polyester-based resin, there was a technique using a monomer mixture that contained a certain amount of styrene in addition to a reactive functional group-containing monomer in polymerization of the polymer. The resin composition thus obtained had a certain degree of transparency because the refractive index of the polyester-based resin and the refractive index of the polymer were equal to each other. However, even in a case where such a resin composition was used, the molded product still whitened.

One or more embodiments of the present invention are to provide a novel whitening inhibitor for a polyester-based resin, said novel whitening inhibitor being capable of providing a polyester-based resin composition capable of providing a molded product having excellent strength and reduced whitening.

The present inventor has made diligent studies without being constrained by consideration of refractive index in order to obtain a molded product whose whitening is reduced. As a result, the present inventor has uniquely obtained a novel finding that, surprisingly, a molded product whose whitening is reduced can be provided in a case where a whitening inhibitor which contains a polymer (A) in accordance with one or more embodiments of the present invention is used, the polymer (A) being obtained by polymerizing: a monomer mixture (A) containing respective specific amounts of a component (a), a component (b), and a component (c); or a monomer mixture (A) containing respective specific amounts of the component (a) and the component (b).

That is, according to one or more embodiments of the present invention, it is possible to provide a whitening inhibitor for a polyester-based resin, the whitening inhibitor being capable of providing a polyester-based resin composition capable of providing a molded product having excellent strength and reduced whitening.

### [2-1. Whitening Inhibitor for Polyester-Based Resin]

The whitening inhibitor for a polyester-based resin in accordance with one or more embodiments of the present invention contains a polymer (A) obtained by polymerizing a monomer mixture (A) containing 10% by weight to 60% by weight of an epoxy group-containing monomer (a) and 40% by weight to 90% by weight of an epoxy group-free monomer (b).

In the present specification, the “whitening inhibitor for a polyester-based resin” may be simply referred to as “whitening inhibitor”.

Since the whitening inhibitor in accordance with one or more embodiments of the present invention has the above configuration, the whitening inhibitor has an advantage of being capable of providing a polyester-based resin composition capable of providing a molded product which has excellent strength and reduced whitening. It can also be said that since the whitening inhibitor in accordance with one or more embodiments of the present invention has the above configuration, the whitening inhibitor can provide a molded product which has excellent strength and reduced whitening.

Specific aspects of the whitening inhibitor are the same as those described in the section (1-1-2. Whitening inhibitor), and accordingly, the description in the section (1-1-2. Whitening inhibitor) is incorporated and an explanation of the specific aspects is omitted here. An aspect described in the section (1-1-2. Whitening inhibitor) may also be an aspect in this section [2-1. Whitening inhibitor for polyester-based resin].

Further, when the description in the section (1-1-2. Whitening inhibitor) is incorporated as an explanation in this section [2-1. Whitening inhibitor for polyester-based resin], the “recycled polyester-based resin” in the section (1-1-2. Whitening inhibitor) may be read as “polyester-based resin” in the explanation of this section [2-1. Whitening inhibitor for polyester-based resin], and the “resin composition” in the section (1-1-2. Whitening inhibitor) may be read as “polyester-based resin composition” in the explanation of this section [2-1. Whitening inhibitor for polyester-based resin].

### [2-2. Polyester-Based Resin Composition]

The polyester-based resin composition in accordance with one or more embodiments of the present invention contains the whitening inhibitor in accordance with one or more embodiments of the present invention described in the section [2-1. Whitening inhibitor for polyester-based resin] above, that is, the whitening inhibitor described in the section (1-1-2. Whitening inhibitor), and a polyester-based resin.

Since the polyester-based resin composition in accordance with one or more embodiments of the present invention has the above configuration, the polyester-based resin composition has an advantage of being capable of providing a molded product which has excellent strength and reduced whitening.

The whitening inhibitor in accordance with one or more embodiments of the present invention can react not only with the recycled polyester-based resin as described above but also with a virgin polyester-based resin. Specifically, the reactive functional group (for example, epoxy group) in the polymer (A) contained in the whitening inhibitor can react with a terminal functional group (for example, hydroxyl group or carboxyl group) of the polyester-based resin. Due to this reaction, the virgin polyester-based resin can have an extended molecular chain. That is, the whitening inhibitor in accordance with one or more embodiments of the present invention can react with all polyester-based resins regardless of whether the polyester-based resins are recycled or virgin (unused), and can extend the molecular chain of the polyester-based resins. Therefore, by producing a polyester-based resin composition by mixing the whitening inhibitor in accordance with one or more embodiments of the present invention and a polyester-based resin, (i) the melt viscosity of the polyester-based resin composition can be improved, and the strength of a molded product composed of the polyester-based resin composition can be increased, and (ii) whitening of the molded product containing the polyester-based resin can be suppressed.

### (2-2-1. Polyester-Based Resin)

Specific examples of the polyester-based resin are not particularly limited, and examples of the polyester-based resin include polyethylene terephthalate, polypropylene terephthalate, polybutylene terephthalate, polyethylene-2,6-naphthalate, polybutylene naphthalate, poly-1,4-cyclohexylenedimethylene terephthalate, polyethylene-1,2-bis(phenoxy)ethane-4,4′-dicarboxylate, polyethylene isophthalate/terephthalate, polybutylene terephthalate/isophthalate, polybutylene terephthalate/decanedicarboxylate, polycyclohexanedimethylene terephthalate/isophthalate, polyester/polyether, and glycol-modified polyethylene terephthalate. The glycol-modified polyethylene terephthalate refers to a copolymer of terephthalic acid, ethylene glycol, and a glycol component other than ethylene glycol.

From the viewpoint of moldability and mechanical properties, the polyester-based resin (i) may contain one or more selected from the group consisting of polypropylene terephthalate, polybutylene terephthalate, polyethylene-2,6-naphthalate, polybutylene naphthalate, poly-1,4-cyclohexylenedimethylene terephthalate, and polyester/polyether and may be composed only of one or more selected from the group; or (ii) may contain one or more selected from the group consisting of polyethylene terephthalate and polybutylene terephthalate and may be composed only of one or more selected from the group.

As the polyester-based resin, a polymer alloy obtained from a mixture of multiple types of polymers including a polyester-based resin may be used. Examples of the polymer alloy include polycarbonate/polyethylene terephthalate, polyethylene terephthalate/glycol-modified polyethylene terephthalate, and polyethylene terephthalate/copolymerized polyethylene terephthalate. In other words, the polyester-based resin may contain one or more selected from the group consisting of polycarbonate/polyethylene terephthalate, polyethylene terephthalate/glycol-modified polyethylene terephthalate, and polyethylene terephthalate/copolymerized polyethylene terephthalate, and may be composed only of one or more selected from the group. Note that the copolymerized polyethylene terephthalate means a resin in which a component (third component) other than the components (two components) constituting polyethylene terephthalate is copolymerized.

Aspects other than those described above with regard to the polyester-based resin are the same as those described in the section (1-1-1. Recycled polyester-based resin), and accordingly, the description in the above section (1-1-1. Recycled polyester-based resin) is incorporated and an explanation of the aspects is omitted here. In particular, among the aspects described in the section (1-1-1. Recycled polyester-based resin), aspects other than being recycled can be regarded as aspects concerning the polyester-based resin and incorporated as appropriate. An aspect described in the section (1-1-1. Recycled polyester-based resin) may also be an aspect in this section (2-2-1. Polyester-based resin).

Conventionally, in a case where the following (i) and (ii) are recycled, the melt viscosity obtained tends to decrease due to moisture and/or heating in a process of recycling:
(i) a polyester-based resin composition and/or a molded product that has been once made as a product in the form of a polyester-based resin composition and/or a molded product, and used and/or discarded; and/or
(ii) a waste polyester-based resin composition and/or a waste molded product which has been discharged in a production process of a polyester-based resin composition and/or a molded product.

In other words, the recycled polyester-based resin tends to have a lower melt viscosity than an unused product. Therefore, conventionally, a recycled polyester-based resin tended to have limited applications for reuse due to a low melt viscosity. Further, a technique according to which, when the recycled polyester-based resin is used, a viscosity modifier is added to the recycled polyester-based resin to improve, to a certain extent, the melt viscosity of a resin composition containing the recycled polyester-based resin has also been known. However, a molded product obtained from a resin composition containing a conventional viscosity modifier whitened. Therefore, the applications for reuse of the recycled polyester-based resin tended to be limited due to whitening of the molded product obtained. However, the whitening inhibitor in accordance with one or more embodiments of the present invention has an advantage in that, in a case where the whitening inhibitor is mixed with the recycled polyester-based resin, the melt viscosity of the resin composition obtained can be improved and a molded product whose whitening is reduced can be provided. Therefore, one or more embodiments of the present invention have an advantage in that the applications for reuse of the recycled polyester-based resin can be greatly broadened, and in particular, one or more embodiments of the present invention can greatly contribute to expansion into applications (for example, alcoholic beverage bottles, beverage bottles, etc.) that require strength and high transparency.

In a case where the polyester-based resin contains a recycled polyester-based resin, one or more embodiments of the present invention can significantly reduce an amount of plastic waste generated and an amount of plastic used for production. Thus, one or more embodiments of the present invention can contribute to the achievement of Sustainable Development Goals (SDGs) such as Goal 12 “Ensure sustainable consumption and production patterns”.

In the polyester-based resin composition in accordance with one or more embodiments of the present invention, the content of the whitening inhibitor is not particularly limited. In the polyester-based resin composition in accordance with one or more embodiments of the present invention, the content of the whitening inhibitor may be 0.1% by weight to 10.0% by weight with respect to 100% by weight of the polyester-based resin composition. The lower limit of the content may be not less than 0.2% by weight. The upper limit of the content may be not more than 8.0% by weight, not more than 6.0% by weight, or not more than 4.0% by weight. In a case where the content of the whitening inhibitor in the polyester-based resin composition is within the above range, there is an advantage in that the balance between improvement in melt viscosity and suppression of whitening becomes favorable.

The polyester-based resin composition in accordance with one or more embodiments of the present invention may be a masterbatch containing 10.0% by weight to 90.0% by weight of the whitening inhibitor with respect to 100% by weight of the resin composition. It can also be said that a polyester-based resin composition containing 10.0% by weight to 90.0% by weight of the whitening inhibitor with respect to 100% by weight of the polyester-based resin composition can be used as a masterbatch. In a case where the polyester-based resin composition in accordance with one or more embodiments of the present invention is used as a masterbatch, the content of the whitening inhibitor in the polyester-based resin composition may be 10.0% by weight to 90.0% by weight with respect to 100% by weight of the polyester-based resin composition. The lower limit of the content may be not less than 20.0% by weight. The upper limit of the content may be not more than 80.0% by weight. In a case where the content of the whitening inhibitor in the polyester-based resin composition is within the above range, there is an advantage in that dispersibility of the whitening inhibitor in the polyester-based resin becomes favorable in a case where the polyester-based resin composition is used as a masterbatch.

A method of producing the masterbatch is not particularly limited. Examples of the method include a melting and kneading method and a dry blend method, and the melting and kneading method is particularly preferable.

### (2-2-2. Other Resins)

The polyester-based resin composition in accordance with one or more embodiments of the present invention may or may not further contain a resin other than the polyester-based resin. Specific examples of the resin other than the polyester-based resin are the same as those described in the section (1-1-3. Other resins), and accordingly, the description in the section (1-1-3. Other resins) is incorporated and an explanation of other resins is omitted here.

The content of the resin other than the polyester-based resin in the polyester-based resin composition in accordance with one or more embodiments of the present invention is not particularly limited, but may be, for example, 0 parts by weight to 60 parts by weight with respect to 100 parts by weight of the polyester-based resin. The upper limit of the content may be not more than 50 parts by weight, not more than 40 parts by weight, not more than 30 parts by weight, not more than 20 parts by weight, not more than 10 parts by weight, not more than 5 parts by weight, or not more than 1 part by weight.

### (2-2-3. Other Additives)

The polyester-based resin composition in accordance with one or more embodiments of the present invention may contain another additive. Specific examples of the another additive are the same as those described in the section (1-1-4. Other additives), and accordingly, the description in the section (1-1-4. Other additives) is incorporated and an explanation of other additives is omitted here.

### (2-2-4. Method for Producing Resin Composition)

A method for producing the polyester-based resin composition in accordance with one or more embodiments of the present invention is not particularly limited, and a general method for producing a resin composition can be applied. For example, the method described in the section (1-1-5. Method for producing resin composition) can be employed, except that a polyester-based resin (recycled polyester-based resin and/or virgin polyester-based resin) is used instead of the recycled polyester-based resin.

### (2-2-5. Physical Properties of Polyester-Based Resin Composition)

The whitening inhibitor in accordance with one or more embodiments of the present invention can provide a polyester-based resin composition capable of providing a molded product which has excellent strength and reduced whitening. Further, the polyester-based resin composition in accordance with one or more embodiments of the present invention (resin composition containing the whitening inhibitor in accordance with one or more embodiments of the present invention and a polyester-based resin) can provide a molded product having excellent strength and reduced whitening.

A polyester-based resin composition having a higher melt viscosity (IV value) can provide a molded product that has more excellent strength. In other words, the whitening inhibitor in accordance with one or more embodiments of the present invention can provide a resin composition that has a higher melt viscosity (IV value) than a resin or resin composition which does not contain the whitening inhibitor and/or than a resin composition which contains a conventional viscosity modifier. The polyester-based resin composition in accordance with one or more embodiments of the present invention has an advantage in that the melt viscosity (IV value) is higher than that of a resin or resin composition which does not contain the whitening inhibitor in accordance with one or more embodiments of the present invention and/or than a resin composition which contains a conventional viscosity modifier. A method of measuring the melt viscosity (IV value) of the polyester-based resin composition will be described in detail in Examples later.

A polyester-based resin composition having a lower MFR can provide a molded product that has more excellent strength. In other words, the whitening inhibitor in accordance with one or more embodiments of the present invention can provide a resin composition that has a lower MFR than a resin or resin composition which does not contain the whitening inhibitor and/or than a resin composition which contains a conventional viscosity modifier. The polyester-based resin composition in accordance with an embodiment has an advantage in that the MFR is lower than that of a resin or resin composition which does not contain the whitening inhibitor in accordance with one or more embodiments of the present invention and/or than a resin composition which contains a conventional viscosity modifier. A method for measuring the MFR of the polyester-based resin composition will be described in detail in Examples later.

### [2-3. Molded Product]

The molded product in accordance with one or more embodiments of the present invention is a molded product which is formed by molding the polyester-based resin composition in accordance with one or more embodiments of the present invention described in the section [2-2. Polyester-based resin composition]. It can also be said that the molded product in accordance with one or more embodiments of the present invention is a molded product which contains the polyester-based resin composition in accordance with one or more embodiments of the present invention described in the section [2-2. Polyester-based resin composition].

Since the molded product in accordance with one or more embodiments of the present invention has the above configuration, the molded product has advantages of having excellent strength and reduced whitening.

### (2-3-1. Method for Producing Molded Product)

A method for producing the molded product in accordance with one or more embodiments of the present invention, in other words, a method for molding the polyester-based resin composition in accordance with one or more embodiments of the present invention, is not particularly limited. The method for producing the molded product may be, for example, the same as the production method described in the section [1-2. Method for producing molded product]. Therefore, the description in the section [1-2. Method for producing molded product] is incorporated, and the explanation of the method for producing the molded product is omitted here. The molded product in accordance with one or more embodiments of the present invention is a molded product which may be formed by blow molding of the polyester-based resin composition in accordance with one or more embodiments of the present invention described in the section [2-2. Polyester-based resin composition].

### (2-3-2. Physical Properties of Molded Product)

The degree of whitening of the molded product can be evaluated by a difference (ΔL) in L value before and after stretching of a film (molded product) which is obtained by molding the resin composition into a film shape. Specifically, the resin composition is molded into a film shape, and a tensile test is performed on a film (molded product) obtained. In a case where the difference (ΔL) in L value before and after stretching is smaller, the resin composition can provide a molded product whose whitening is reduced to a greater extent. For example, in blow molding of a resin composition or an injection-molded product, the resin composition or the injection-molded product is molded while being stretched. It can be said that stretching of the film (molded product) in the tensile test simulates stretching during blow molding of the resin composition or the injection-molded product. Therefore, it can be said that in a case where the ΔL of the film (molded product) is smaller, whitening of a blow-molded product (for example, bottle-shaped molded product) obtained by blow molding is reduced to a greater extent. The film (molded product) in accordance with one or more embodiments of the present invention has an advantage in that the ΔL is smaller than that of a film (molded product) which has been obtained from a resin composition containing a conventional viscosity modifier. In other words, the present whitening inhibitor and the present resin composition have an advantage of being capable of providing a film (molded product) that has a smaller ΔL than a resin composition containing a conventional viscosity modifier.

With regard to ΔL, since ΔL is the same as that described in the section [1-3. Physical properties of molded product], the description in the section [1-3. Physical properties of molded product] is incorporated and an explanation of ΔL is omitted here. It can be said that the numerical range regarding ΔL described in the section [1-3. Physical properties of molded product] may be a numerical range for ΔL also in this section (2-3-2. Physical properties of molded product).

Regarding the haze, total light transmittance (TT), and buckling strength of the molded product in accordance with one or more embodiments of the present invention, since the haze, total light transmittance (TT), and buckling strength are the same as those described in the section [1-3. Physical properties of molded product], the description in the section [1-3. Physical properties of molded product] is incorporated and an explanation of the haze, total transmittance, and buckling strength is omitted here. It can be said that numerical ranges regarding the haze, total light transmittance (TT), and buckling strength of the molded product which are described in the section [1-3. Physical properties of molded product] may be numerical ranges for the haze, total light transmittance (TT), and buckling strength of the molded product also in this section (2-3-2. Physical properties of molded product)

### (2-3-3. Shape of Molded Product)

The shape of the molded product in accordance with one or more embodiments of the present invention is not particularly limited. The shape of the molded product in accordance with one or more embodiments of the present invention may be, for example, each shape described in the section [1-4. Shape of molded product]. Therefore, regarding the shape of the molded product in accordance with one or more embodiments of the present invention, the description in the section [1-4. Shape of molded product] can be incorporated as appropriate. An aspect described in the section [1-4. Shape of molded product] may also be an aspect in this section (2-3-3. Shape of molded product).

### [3. Method for Producing Recycled Polyester-Based Resin Composition]

One or more embodiments of the present invention provide a method for producing a recycled polyester-based resin composition.

Melt viscosity decreases and strength deteriorates each time the polyester-based resins are recycled. Solid state polymerization (which may be referred to as “SSP” in the present specification), which is known as a technique for increasing the melt viscosity of a polyester-based resin, needs to be carried out at a high temperature and a reduced pressure (in vacuum) for a long time, which results in large power consumption, large environmental load, and large production cost.

On the other hand, in addition of a conventional viscosity modifier, which is known as another technique for increasing the melt viscosity of a polyester-based resin, although the melt viscosity of a resin composition is improved to some extent by mixing a matrix resin (polyester-based resin) and the viscosity modifier, a molded product formed by molding the resin composition whitens. Conventionally, in order to address the above, efforts have been made to make the refractive index of the matrix resin and the refractive index of a polymer which is a main component of the viscosity modifier as equal as possible. For example, in a case where the matrix resin was a polyester-based resin, there was a technique using a monomer mixture that contained a certain amount of styrene in addition to a reactive functional group-containing monomer in polymerization of the polymer. The resin composition thus obtained had a certain degree of transparency because the refractive index of the polyester-based resin and the refractive index of the polymer were equal to each other. However, even in a case where such a resin composition was used, the molded product still whitened.

One or more embodiments of the present invention are to provide a novel method for producing a recycled polyester-based resin composition, which uses SSP but has small environmental load and small production cost.

The present inventor has made diligent studies without being constrained by consideration of refractive index in order to obtain a molded product whose whitening is reduced. As a result, the present inventor has uniquely obtained a novel finding that, surprisingly, a molded product whose whitening is reduced can be provided in a case where a whitening inhibitor which contains a polymer (A) in accordance with one or more embodiments of the present invention is used, the polymer (A) being obtained by polymerizing: a monomer mixture (A) containing respective specific amounts of a component (a), a component (b), and a component (c); or a monomer mixture (A) containing respective specific amounts of the component (a) and the component (b). Further, the present inventor has obtained a finding that, in a case where SSP is carried out with use of pellets which are obtained by melting and kneading such a whitening inhibitor and a polyester-based resin, the time required to increase the melt viscosity to a target value can be remarkably shortened.

That is, according to one or more embodiments of the present invention, while SSP is used, it is possible to provide a novel method for producing a recycled polyester-based resin composition which has a small environmental load and production cost.

### [3-1. Method for Producing Recycled Polyester-Based Resin Composition]

A method for producing a recycled polyester-based resin composition in accordance with one or more embodiments of the present invention includes the steps of: preparing pellets including a polyester-based resin and a whitening inhibitor for a polyester-based resin by melting and kneading the polyester-based resin and the whitening inhibitor for a polyester-based resin; and carrying out solid state polymerization using the pellets, the whitening inhibitor for a polyester-based resin containing a polymer (A) obtained by polymerizing a monomer mixture (A) containing 10% by weight to 60% by weight of an epoxy group-containing monomer (a), and 40% by weight to 90% by weight of an epoxy group-free monomer (b).

In the present specification, the “step of preparing pellets including a polyester-based resin and a whitening inhibitor for a polyester-based resin by melting and kneading the polyester-based resin and the whitening inhibitor for a polyester-based resin” may be referred to as “Step I”, and the “step of carrying out solid state polymerization using the pellets” may be referred to as “Step II”. Further, the “whitening inhibitor for a polyester-based resin” may be simply referred to as “whitening inhibitor”, and the “pellets including a polyester-based resin and a whitening inhibitor for a polyester-based resin” may be simply referred to as “pellets”.

### (3-1-1. Step I)

### (3-1-1-1. Whitening Inhibitor)

In one or more embodiments of the present invention, the whitening inhibitor for a polyester-based resin contains a polymer (A) obtained by polymerizing a monomer mixture (A) containing 10% by weight to 60% by weight of an epoxy group-containing monomer (a) and 40% by weight to 90% by weight of an epoxy group-free monomer (b).

Since the whitening inhibitor has the above configuration, the melt viscosity of the polyester-based resin increases by melting and kneading the whitening inhibitor with the polyester-based resin. Thus, it is advantageously possible to provide pellets capable of providing a molded product having an excellent strength and reduced whitening. Therefore, in SSP using pellets having an increased melt viscosity, the time required to increase the melt viscosity to a target value can be shortened. Further, it can also be said that, since the whitening inhibitor has the above configuration, the whitening inhibitor can provide a molded product which has excellent strength and reduced whitening.

In the step of preparing pellets including the polyester-based resin and the whitening inhibitor (for example, during melting and kneading of the polyester-based resin and the whitening inhibitor), a reactive functional group (for example, epoxy group) in the polymer (A) contained in the whitening inhibitor can react with a terminal functional group (for example, hydroxyl group or carboxyl group) of the polyester-based resin. Due to this reaction, the polyester-based resin can have an extended molecular chain; due to this mechanism, the melt viscosity of the pellets is increased. Further, since the pellets have an increased melt viscosity, it is possible to shorten the time required to increase the melt viscosity to a target value in SSP using the pellets. Furthermore, since the whitening inhibitor contains the above-described polymer (A), dispersibility of the whitening inhibitor in the pellets and in the recycled polyester-based resin composition after SSP can be improved. It is inferred that this suppresses whitening of the molded product. Note that one or more embodiments of the present invention are not limited by such mechanism and inference at all.

The content of the component (a) (epoxy group-containing monomer (a)) in the monomer mixture (A) is not particularly limited, but may be 10% by weight to 60% by weight with respect to 100% by weight of the monomer mixture (A). The upper limit of the content may be 55% by weight, 50% by weight, 45% by weight, or 40% by weight, and the lower limit of the content may be 15% by weight, 20% by weight, 25% by weight, or 30% by weight. In a case where the content of the component (a) is within the above range, the effect of improving the melt viscosity of the pellets can be favorable. As a result, in SSP using the pellets, the time required to increase the melt viscosity to a target value can be shortened. Furthermore, there is an advantage in that a molded product obtained with use of the recycled polyester-based resin composition obtained after SSP has more excellent strength.

The content of the component (b) (epoxy group-free monomer (b)) in the monomer mixture (A) is not particularly limited, but may be 40% by weight to 90% by weight with respect to 100% by weight of the monomer mixture (A). The upper limit of the content may be 85% by weight, 80% by weight, 75% by weight, or 70% by weight, and the lower limit of the content may be 45% by weight, 50% by weight, 55% by weight, or 60% by weight. In a case where the content of the component (b) is within the above range, there is an advantage in that the dispersibility of the whitening inhibitor in the pellets and in the recycled polyester-based resin composition after SSP can be improved. This can lead to also having an advantage in that whitening of the molded product obtained is further suppressed.

Aspects other than those described above regarding the whitening inhibitor are the same as those described in the section (1-1-2. Whitening inhibitor), and accordingly, the description in the section (1-1-2. Whitening inhibitor) is incorporated and an explanation of the aspects is omitted here. An aspect described in the section (1-1-2. Whitening inhibitor) may also be an aspect in this section (3-1-1-1. Whitening inhibitor).

Further, when the description in the section (1-1-2. Whitening inhibitor) is incorporated as an explanation in this section (3-1-1-1. Whitening inhibitor), the “recycled polyester-based resin” in the section (1-1-2. Whitening inhibitor) may be read as “polyester-based resin” in the explanation of this section (3-1-1-1. Whitening inhibitor).

### (3-1-1-2. Polyester-Based Resin)

Specific examples of the polyester-based resin are the same as those described in the section (2-2-1. Polyester-based resin), and accordingly, the description in the section (2-2-1. Polyester-based resin) is incorporated and an explanation of the polyester-based resin is omitted here. A specific example in the section (2-2-1. Polyester-based resin) may also be an example in this section (3-1-1-2. Polyester-based resin).

Further, aspects regarding the polyester-based resin other than the specific examples of the polyester-based resin may be the same as those described in the section (1-1-1. Recycled polyester-based resin), and accordingly, the description in the above section (1-1-1. Recycled polyester-based resin) is incorporated and an explanation of the aspects is omitted here. In particular, among the aspects described in the section (1-1-1. Recycled polyester-based resin), aspects other than being recycled can be regarded as aspects concerning the polyester-based resin and incorporated as appropriate. An aspect in the section (1-1-1. Recycled polyester-based resin) can also be an aspect in this section (3-1-1-2. Polyester-based resin).

The polyester-based resin may contain the following (i), (ii), and/or (iii):
(i) a polyester-based resin composition and/or a molded product that has been once made as a product in the form of a polyester-based resin composition and/or a molded product, and used and/or discarded;
(ii) a waste polyester-based resin composition and/or a waste molded product which has been discharged in a production process of a polyester-based resin composition and/or a molded product; and/or
(iii) a polyester-based resin obtained by recycling the above (i) and/or (ii).

Examples of the above (i) include, for example, crushed materials (flakes or the like) obtained by collecting, cleaning, and crushing a used and/or discarded polyester-based resin composition and/or a molded product.

Examples of the above (iii) include, for example, a polyester-based resin composition and/or a molded product which has been produced by carrying out material recycling using (i) and/or (ii) as a raw material (s).

In a case where the polyester-based resin includes a polyester-based resin as described above, one or more embodiments of the present invention can significantly reduce an amount of plastic waste generated and an amount of plastic used for production. Thus, one or more embodiments of the present invention can contribute to the achievement of Sustainable Development Goals (SDGs) such as Goal 12 “Ensure sustainable consumption and production patterns”.

On the other hand, a polyester-based resin that has never been made into a product may be referred to as a “virgin polyester-based resin” in the present specification. In one or more embodiments of the present invention, the polyester-based resin used also includes a mixture obtained by mixing the above-mentioned (i), (ii), and/or (iii) with a “virgin polyester-based resin”.

Conventionally, in a case where the following (i) and (ii) are recycled, the melt viscosity obtained tends to decrease due to moisture and/or heating in a process of recycling. Further, the polyester-based resin of (iii) itself may be a resin whose melt viscosity has already decreased. Therefore, conventionally, a recycled polyester-based resin tended to have limited applications for reuse due to a low melt viscosity.

According to the method for producing a recycled polyester-based resin composition in accordance with one or more embodiments of the present invention, in Step I, it is possible to prepare, by mixing the whitening inhibitor with the polyester-based resin, pellets that have increased melt viscosity and that is capable of providing a molded product having reduced whitening in a case where the recycled polyester-based resin composition obtained is made into the molded product. Then, in Step II, it is possible to produce, by carrying out SSP using the pellets, a recycled polyester-based resin which has a high melt viscosity while shortening the time required to increase the melt viscosity to a target value and reducing the environmental load and production cost.

Therefore, one or more embodiments of the present invention has an advantage in that applications for reuse of the recycled polyester-based resin can be greatly broadened, and in particular, one or more embodiments of the present invention can greatly contribute to expansion into applications (for example, alcoholic beverage bottles, beverage bottles, etc.) that require strength and high transparency.

### (3-1-1-3. Preparation of Pellets)

In Step I, the polyester-based resin and the whitening inhibitor for a polyester-based resin are melted and kneaded, and thus pellets containing the polyester-based resin and the whitening inhibitor for a polyester-based resin are prepared.

In the pellets obtained in Step I, the content of the whitening inhibitor is not particularly limited, but may be 0.1% by weight to 10.0% by weight with respect to 100% by weight of the pellets. The lower limit of the content may be not less than 0.2% by weight. The upper limit of the content may be not more than 8.0% by weight, not more than 6.0% by weight, or not more than 4.0% by weight. In a case where the content of the whitening inhibitor in the pellets is within the above range, there is an advantage in that the balance between improvement in melt viscosity and suppression of whitening becomes favorable.

In preparation of the pellets, a masterbatch which may contain 10.0% by weight to 90.0% by weight of the whitening inhibitor with respect to 100% by weight of the polyester-based resin composition may be used. In a case where such a masterbatch is used, the lower limit of the content of the whitening inhibitor in the masterbatch may be not less than 20.0% by weight with respect to 100% by weight of the polyester-based resin composition. The upper limit of the content may be not more than 80.0% by weight. In a case where the content of the whitening inhibitor in the masterbatch is within the above range, there is an advantage in that dispersibility of the whitening inhibitor in the polyester-based resin becomes favorable.

A method of producing the masterbatch is not particularly limited. Examples of the method include a melting and kneading method and a dry blend method, and the melting and kneading method is particularly preferable.

In Step I, a resin other than the polyester-based resin may be further contained. Specific examples of the resin other than the polyester-based resin are the same as those described in the section (1-1-3. Other resins), and accordingly, the description in the section (1-1-3. Other resins) is incorporated and an explanation of other resins is omitted here.

The content of the resin other than the polyester-based resin in the pellets obtained in Step I is not particularly limited, but may be, for example, 0 parts by weight to 60 parts by weight with respect to 100 parts by weight of the polyester-based resin. The upper limit of the content may be not more than 50 parts by weight, not more than 40 parts by weight, not more than 30 parts by weight, not more than 20 parts by weight, not more than 10 parts by weight, not more than 5 parts by weight, or not more than 1 part by weight.

In Step I, another additive may be added. Specific examples of the another additive are the same as those described in the section (1-1-4. Other additives), and accordingly, the description in the section (1-1-4. Other additives) is incorporated and an explanation of other additives is omitted here.

In Step I, a method of melting and kneading the whitening inhibitor and the polyester-based resin is not particularly limited, and a general method of producing a resin composition can be applied. For example, the polyester-based resin composition can be obtained by: mixing the polyester-based resin and the whitening inhibitor by a Henschel mixer, a tumbler mixer, or the like; and then melting and kneading a mixture obtained. For the melting and kneading, a kneader such as a single-screw or twin-screw extruder, a Banbury mixer, a pressure kneader, or a mixing roll can be used. By such melting and kneading, the pellets can be produced.

In a case where the pellets have a higher the melt viscosity (IV value), the time required to increase the melt viscosity of the recycled polyester-based resin composition to a target value can be shortened more in Step II of carrying out SSP. Further, the whitening inhibitor can provide pellets having a higher melt viscosity (IV value) as compared with a case in which the whitening inhibitor is not contained and/or as compared with a case in which a conventional viscosity modifier is contained. A method of measuring the melt viscosity (IV value) of the pellets will be described in detail in Examples later.

Further, in a case where the pellets have a lower MFR, the recycled polyester-based resin composition obtained by carrying out SSP using the pellets can provide a molded product having a more excellent strength. In other words, the whitening inhibitor can provide a recycled polyester-based resin composition having a lower MFR as compared with a case in which the whitening inhibitor is not contained and/or as compared with a case in which a conventional viscosity modifier is contained. A method of measuring the MFR of the resin composition will be described in detail in Examples later.

### (3-1-2. Step II)

Step II is a step of carrying out solid state polymerization using the pellets which have been prepared in Step I. A method of solid state polymerization is not particularly limited, and a reactor and reaction conditions suitable for solid state polymerization can be selected, as appropriate.

Step II may include, for example, a crystallization step of drying and crystallizing the pellets, a temperature-increasing step of further heating the pellets which have been crystallized, and a polymerization step of carrying out solid state polymerization.

The crystallization step is, for example, a step of drying and crystallizing the pellets by heating the pellets to 120° C. to 150° C. under a prescribed pressure. The order of drying and crystallization is not particularly limited, and either of drying and crystallization may be carried out first, or drying and crystallization may be carried out concurrently. Further, in a case where drying and crystallization are carried out concurrently, the entire drying step and the entire crystallization step may be carried out concurrently, or either one may be started and/or finished first. A period of time for carrying out drying and crystallization is also not particularly limited; for example, the period of time is 1.0 hour to 5.0 hours.

The temperature-increasing step is for further increasing the temperature of the pellets which have been crystallized. Temperature increase may be carried out, for example, under a prescribed pressure. Further, the temperature increase may increase the temperature of the pellets to, for example, 150° C. to 230° C. A period of time from the start to the end of the temperature increase is also not particularly limited; for example, the period of time is 1.0 hour to 5.0 hours. In the temperature-increasing step, gas may be removed.

The solid state polymerization may be carried out in an inert gas such as nitrogen gas under a prescribed pressure. Typically, the solid state polymerization may be carried out at a temperature in a range of 200° C. to 250° C., or may be carried out at a temperature in a range of 220° C. to 240° C.

Step II may further include a preheating step of preheating the pellets before the crystallization step.

In the recycled polyester-based resin composition which is obtained by the method for producing a recycled polyester-based resin composition in accordance with one or more embodiments of the present invention, the content of the whitening inhibitor is not particularly limited, but may be 0.1% by weight to 10.0% by weight with respect to 100% by weight of the recycled polyester-based resin composition. The lower limit of the content may be not less than 0.2% by weight. The upper limit of the content may be not more than 8.0% by weight, not more than 6.0% by weight, or not more than 4.0% by weight. In a case where the content of the whitening inhibitor in the pellets is within the above range, there is an advantage in that the balance between improvement in melt viscosity and suppression of whitening becomes favorable.

A recycled polyester-based resin composition having a higher melt viscosity (IV value) can provide a molded product that has more excellent strength.

A recycled polyester-based resin composition having a lower MFR can provide a molded product that has more excellent strength. The MFR of the recycled polyester-based resin composition may be 3.7 to 30.0, 5.0 to 25.0, or 10.0 to 20.0.

### [3-2. Method for Producing Molded Product]

A method for producing a molded product in accordance with one or more embodiments of the present invention includes a step of molding the recycled polyester-based resin composition which has been obtained by the method described in the section [3-1. Method for producing recycled polyester-based resin composition].

According to the method for producing a molded product in accordance with one or more embodiments of the present invention, since the method has the above configuration, the method has an advantage in that a molded product having excellent strength and reduced whitening can be produced.

A molding method is not particularly limited, and may be, for example, the same as the production method described in the section [1-2. Method for producing molded product]. Therefore, the description in the section [1-2. Method for producing molded product] is incorporated, and the explanation of the method for producing the molded product is omitted here. In one or more embodiments of the present invention, the step of molding may be a blow molding step.

Since the blow molding method has already been described in the section [1-2. Method for producing molded product], the description is incorporated and an explanation of the method is omitted here.

### [3-3. Physical Properties of Molded Product]

The degree of whitening of the molded product obtained by the method for producing a molded product in accordance with one or more embodiments of the present invention can be evaluated by a difference (ΔL) in L value before and after stretching of a film (molded product) that has been formed by molding the recycled polyester-based resin composition into a film shape. Specifically, the recycled polyester-based resin composition is molded into a film shape, and a tensile test is performed on a film (molded product) obtained. In a case where the difference (ΔL) in L value before and after stretching is smaller, the recycled polyester-based resin composition can provide a molded product whose whitening is reduced to a greater extent. For example, in blow molding of a resin composition or an injection-molded product, the resin composition or the injection-molded product is molded while being stretched. It can be said that stretching of the film (molded product) in the tensile test simulates stretching during blow molding of the resin composition or the injection-molded product. Therefore, it can be said that in a case where the ΔL of the film (molded product) is smaller, whitening of a blow-molded product (for example, bottle-shaped molded product) obtained by blow molding is reduced to a greater extent. The film (molded product) in accordance with one or more embodiments of the present invention has an advantage in that the ΔL is smaller than that of a film (molded product) which has been obtained from a recycled polyester-based resin composition containing a conventional viscosity modifier. In other words, the whitening inhibitor and the recycled polyester-based resin composition have an advantage of being capable of providing a film (molded product) that has a smaller ΔL than a resin composition containing a conventional viscosity modifier.

With regard to ΔL, since ΔL is the same as that described in the section [1-3. Physical properties of molded product], the description in the section [1-3. Physical properties of molded product] is incorporated and an explanation of ΔL is omitted here. It can be said that the numerical range regarding ΔL described in the section [1-3. Physical properties of molded product] may be a numerical range for ΔL also in this section [3-3. Physical properties of molded product].

Regarding the haze, total light transmittance (TT), and buckling strength of the molded product which is obtained by the method for producing a molded product in accordance with one or more embodiments of the present invention, since the haze, total light transmittance (TT), and buckling strength are the same as those described in the section [1-3. Physical properties of molded product], the description in the section [1-3. Physical properties of molded product] is incorporated and an explanation of the haze, total transmittance, and buckling strength is omitted here. It can be said that numerical ranges regarding the haze, total light transmittance (TT), and buckling strength of the molded product which are described in the section [1-3. Physical properties of molded product] may be numerical ranges for the haze, total light transmittance (TT), and buckling strength of the molded product also in this section [3-3. Physical properties of molded product].

The shape of the molded product in accordance with one or more embodiments of the present invention is not particularly limited. The shape of the molded product in accordance with one or more embodiments of the present invention may be, for example, each shape described in the section [1-4. Shape of molded product]. Therefore, regarding the shape of the molded product in accordance with one or more embodiments of the present invention, the description in the section [1-4. Shape of molded product] can be incorporated as appropriate. An aspect described in the section [1-4. Shape of molded product] may also be an aspect in this section [3-3. Physical properties of molded product].

### [4. Method for Producing Molded Product]

The method for producing a molded product in accordance with one or more embodiments of the present invention includes the steps of: preparing a recycled polyester-based resin composition; and molding the recycled polyester-based resin composition, the step of preparing the recycled polyester-based resin composition including the steps of: preparing pellets including a polyester-based resin and a whitening inhibitor for a polyester-based resin by melting and kneading the polyester-based resin and the whitening inhibitor for a polyester-based resin; and carrying out solid state polymerization using the pellets, the whitening inhibitor for a polyester-based resin containing a polymer (A) obtained by polymerizing a monomer mixture (A) containing 10% by weight to 60% by weight of an epoxy group-containing monomer (a), and 40% by weight to 90% by weight of an epoxy group-free monomer (b).

Since the method for producing a molded product in accordance with one or more embodiments of the present invention has the above configuration, the method has an advantage of being capable of providing a molded product having excellent strength and reduced whitening.

### (4-1. Recycled Polyester-Based Resin Composition)

The recycled polyester-based resin composition which is used in the method for producing a molded product in accordance with one or more embodiments of the present invention may be a resin composition containing a recycled polyester-based resin, for example, the resin composition described in the section [1-1. Resin composition]. Further, the recycled polyester-based resin composition used in the method for producing a molded product in accordance with one or more embodiments of the present invention may be a recycled polyester-based resin composition obtained by production using the production method described in the section [3. Method for Producing Recycled Polyester-Based Resin Composition]. Therefore, regarding specific aspects of the recycled polyester-based resin composition used in the method for producing a molded product in accordance with one or more embodiments of the present invention, the description in the section [1-1. Resin composition] and the description in the section [3. Method for Producing Recycled Polyester-Based Resin Composition] can be incorporated as appropriate. Further, aspects described in the section [1-1. Resin composition] and the section [3. Method for Producing Recycled Polyester-Based Resin Composition] can also be aspects in this section (4-1. Recycled polyester-based resin composition).

### (4-2. Whitening Inhibitor)

The whitening inhibitor which is used in the method for producing a molded product in accordance with one or more embodiments of the present invention may be (i) for example, the whitening inhibitor described in the section (1-1-2. Whitening inhibitor), (ii) for example, the whitening inhibitor described in the section [2. Whitening Inhibitor], or (iii) for example, the whitening inhibitor described in the section (3-1-1-1. Whitening inhibitor). Therefore, regarding specific aspects of the whitening inhibitor used in the method for producing a molded product in accordance with one or more embodiments of the present invention, the description in the section (1-1-2. Whitening inhibitor), the description in the section [2. Whitening Inhibitor], and the description in the section (3-1-1-1. Whitening inhibitor) can be incorporated as appropriate. Aspects described in the section (1-1-2. Whitening inhibitor), the section [2. Whitening Inhibitor], and the section (3-1-1-1. Whitening inhibitor) can also be aspects in this section (4-2. Whitening inhibitor).

### (4-3. Step of Preparing Recycled Polyester-Based Resin Composition)

The method for producing a molded product in accordance with one or more embodiments of the present invention includes the step of preparing a recycled polyester-based resin composition. The step of preparing a recycled polyester-based resin composition may include, as one step, for example, the method for producing a recycled polyester-based resin composition in accordance with one or more embodiments of the present invention described in the section [3. Method for Producing Recycled Polyester-Based Resin Composition]. Therefore, regarding specific aspects of the step of preparing a recycled polyester-based resin composition in the method for producing a molded product in accordance with one or more embodiments of the present invention, the description in the section [3. Method for Producing Recycled Polyester-Based Resin Composition] can be incorporated as appropriate. Further, an aspect described in the section [3. Method for Producing Recycled Polyester-Based Resin Composition] can also be an aspect in this section (4-3. Step of preparing recycled polyester-based resin composition).

The step of preparing a recycled polyester-based resin composition includes the steps of: preparing pellets including a polyester-based resin and a whitening inhibitor for a polyester-based resin by melting and kneading the polyester-based resin and the whitening inhibitor for a polyester-based resin; and carrying out solid state polymerization using the pellets.

The “step of preparing pellets including a polyester-based resin and a whitening inhibitor for a polyester-based resin by melting and kneading the polyester-based resin and the whitening inhibitor for a polyester-based resin” may be, for example, Step I described in the section (3-1-1. Step I). Therefore, regarding specific aspects of the “step of preparing pellets including a polyester-based resin and a whitening inhibitor for a polyester-based resin by melting and kneading the polyester-based resin and the whitening inhibitor for a polyester-based resin” in the method for producing a molded product in accordance with one or more embodiments of the present invention, the description in the section (3-1-1. Step I) can be incorporated as appropriate. The aspect described in the section (3-1-1. Step I) can also be an aspect in the “step of preparing pellets including a polyester-based resin and a whitening inhibitor for a polyester-based resin by melting and kneading the polyester-based resin and the whitening inhibitor for a polyester-based resin” in the method for producing a molded product in accordance with one or more embodiments of the present invention.

The “step of carrying out solid state polymerization using the pellets” may be, for example, Step II described in the section (3-1-2. Step II). Therefore, regarding specific aspects of the “step of carrying out solid state polymerization using the pellets” in the method for producing a molded product in accordance with one or more embodiments of the present invention, the description in the section (3-1-2. Step II) can be incorporated as appropriate. An aspect described in the section (3-1-2. Step II) can also be an aspect in the “step of carrying out solid state polymerization using the pellets” in the method for producing a molded product in accordance with one or more embodiments of the present invention.

### (4-4. Step of Molding Recycled Polyester-Based Resin Composition)

In the method for producing a molded product in accordance with one or more embodiments of the present invention, a method of molding the recycled polyester-based resin composition is not particularly limited. In the method for producing a molded product in accordance with one or more embodiments of the present invention, as the method for molding a recycled polyester-based resin composition, in other words, as the method for producing a molded product, the production method described in [1-2. Method for producing molded product] can be employed. Therefore, regarding specific aspects of the step of “molding a recycled polyester-based resin composition” in the method for producing a molded product in accordance with one or more embodiments of the present invention, the description in the section [1-2. Method for producing molded product] can be incorporated as appropriate. An aspect described in the section [1-2. Method for producing molded product] can also be an aspect in the “step of molding the recycled polyester-based resin composition” in the method for producing a molded product in accordance with one or more embodiments of the present invention.

### [5. Applications]

With regard to (i) the whitening inhibitor for a polyester-based resin in accordance with one or more embodiments of the present invention described, for example, in the section [2. Whitening Inhibitor], (ii) the polyester-based resin composition in accordance with one or more embodiments of the present invention described, for example, in the section [2. Whitening Inhibitor], (iii) the recycled polyester-based resin composition obtained by one or more embodiments of the present invention, that is, the recycled polyester-based resin composition obtained by the production method described, for example, in the section [3. Method for Producing Recycled Polyester-Based Resin Composition], and (iv) the molded product in accordance with one or more embodiments of the present invention, which is described, for example, in the section [1. Molded product] and/or the section [2. Whitening Inhibitor], and/or which is obtained by the production method described, for example, in the section [3. Method for Producing Recycled Polyester-Based Resin Composition], the following are suitable example applications, but the applications are not particularly limited thereto: automotive applications such as cylinder head covers, engine covers, intake manifolds, radiator tanks, oil pans, accelerator pedals, canisters, fuel tubes, air brake tubes, exhaust gas tubes, hydrogen injectors, ducts, industrial fasteners, and door mirror stays; electric/electronic applications such as coil bobbins, connectors, gears, sockets, switches, electric blanket coated wires, optical fiber cable coating materials, electric tools, and wire binding materials; mechanical applications such as hydraulic/pneumatic connectors/tubes, bearings, covers/housings, bearings, pressure-resistant hoses, and cable ties; building material applications such as curtain rail parts, corners of aluminum sashes, door rollers, handrails, curtain rollers, and door handles; sports/leisure applications such as sports shoe soles, ski/snowboard equipment, reels, and diving snorkels; packaging material/container applications such as shrink packaging films, food packaging films, alcoholic beverage bottles, beverage bottles, and agricultural chemical bottles; and medical applications such as toothbrushes, chair legs and armrests, and sutures. These are examples of the applications but the applications are not particularly limited to the above examples. The molded product may be a bottle.

One or more embodiments of the present invention may be configured as follows.

<1> A molded product obtained by molding a resin composition containing a recycled polyester-based resin, the molded product having a solution haze of not less than 1.50%, and a haze of not more than 7.5%,
the solution haze of the molded product being a value measured by performing the following (1) and (2) in order:
   (1) obtaining a solution whose concentration of the resin composition is 0.05 g/mL, by dissolving the resin composition in hexafluoro-2-propanol; and
   (2) measuring the solution haze of the solution of the molded product by use of a haze meter which has been zero-adjusted with hexafluoro-2-propanol; and
the haze of the molded product being a value measured by use of the haze meter.

<2> The molded product according to <1>, wherein:
the resin composition has a melt flow rate (MFR) of 3.7 g/10 min to 30.0 g/10 min,
where the MFR is a value obtained by measurement under conditions of drying at 130° C. for 8 hours, a temperature of 270° C., and a load of 2.16 kg, in accordance with JIS K 7210-1.

<3> The molded product according to <1> or <2>, having a total light transmittance (TT) of not less than 80.0%,
where the total light transmittance (TT) of the molded product is a value obtained by use of the haze meter.

<4> The molded product according to any one of <1> to <3>, wherein the recycled polyester-based resin contains one or more selected from the group consisting of recycled [polycarbonate/polyethylene terephthalate], recycled [polyethylene terephthalate/glycol-modified polyethylene terephthalate], and recycled [polyethylene terephthalate/copolymerized polyethylene terephthalate].

<5> The molded product according to any one of <1> to <4>, having a bottle shape.

<6> The molded product according to any one of <1> to <5>, wherein: the resin composition further contains a whitening inhibitor for a polyester-based resin; and the whitening inhibitor for a polyester-based resin contains a polymer (A) obtained by polymerizing a monomer mixture (A) containing 10% by weight to 60% by weight of an epoxy group-containing monomer (a) and 40% by weight to 90% by weight of an epoxy group-free monomer (b).

<7> The molded product according to <6>, wherein the monomer mixture (A) further contains 0% by weight to 10% by weight of a vinyl monomer (c) other than the component (a) and the component (b), the vinyl monomer (c) being copolymerizable with the component (a) and the component (b).

<8> The molded product according to <6> or <7>, wherein the epoxy group-free monomer (b) is an epoxy group-free alkyl methacrylate.

<9> The molded product according to any one of <6> to <8>, wherein the polymer (A) has a number average molecular weight of 2,000 to 6,000.

<10> The molded product according to any one of <6> to <9>, wherein the polymer (A) has 2 to 8 reactive functional groups on average per molecule of the polymer (A).

<11> The molded product according to any one of <6> to <10>, wherein the whitening inhibitor for a polyester-based resin does not contain the polymer (A) having a molecular weight of not more than 1000 or contains not more than 4.00% by weight of the polymer (A) having a molecular weight of not more than 1000 with respect to 100% by weight of the whitening inhibitor for a polyester-based resin.

<12> The molded product according to any one of <6> to <11>, wherein:
the whitening inhibitor for a polyester-based resin further includes a polymer (B);
a composite consisting of the polymer (A) and the polymer (B) has a core-shell structure in which the polymer (A) forms a core portion and the polymer (B) forms a shell; and
in the composite, a weight ratio of the polymer (A) and the polymer (B) (weight of the polymer (A)/weight of the polymer (B)) is 20/80 to 80/20.

<13> The molded product according to <12>, wherein, in the composite,
the number average molecular weight of the polymer (A) is 2,000 to 5,000, and
the number average molecular weight of the polymer (B) is 3,000 to 6,000.

<14> The molded product according to any one of <6> to <13>, wherein the polymer (A) is obtained by emulsion polymerization.

<15> A whitening inhibitor for a polyester-based resin, the whitening inhibitor containing a polymer (A) obtained by polymerizing a monomer mixture (A) containing
10% by weight to 60% by weight of an epoxy group-containing monomer (a), and
40% by weight to 90% by weight of an epoxy group-free monomer (b).

<16> A method for producing a molded product, including the steps of:
preparing a recycled polyester-based resin composition; and
molding the recycled polyester-based resin composition,
the step of preparing the recycled polyester-based resin composition including the steps of:
   preparing pellets including a polyester-based resin and a whitening inhibitor for a polyester-based resin by melting and kneading the polyester-based resin and the whitening inhibitor for a polyester-based resin; and
   carrying out solid state polymerization using the pellets,
   the whitening inhibitor for a polyester-based resin containing a polymer (A) obtained by polymerizing a monomer mixture (A) containing
      10% by weight to 60% by weight of an epoxy group-containing monomer (a), and
      40% by weight to 90% by weight of an epoxy group-free monomer (b).

<17> The method according to <16>, wherein the recycled polyester-based resin composition has an MFR of 3.7 to 30.0.

One or more embodiments of the present invention may be configured as follows.

<A1> A whitening inhibitor for a polyester-based resin, the whitening inhibitor containing a polymer (A) obtained by polymerizing a monomer mixture (A) containing 10% by weight to 60% by weight of an epoxy group-containing monomer (a) and 40% by weight to 90% by weight of an epoxy group-free monomer (b).

<A2> The whitening inhibitor according to <A1> for a polyester-based resin, wherein the monomer mixture (A) further contains 0% by weight to 10% by weight of a vinyl monomer (c) other than the (a) and the (b), the vinyl monomer (c) being copolymerizable with the (a) and the (b).

<A3> The whitening inhibitor according to <A1> or <A2> for a polyester-based resin, wherein the epoxy group-free monomer (b) is an epoxy group-free alkyl methacrylate.

<A4> The whitening inhibitor according to any one of <A1> to <A3> for a polyester-based resin, wherein the polymer (A) has a number average molecular weight of 2,000 to 6,000.

<A5> The whitening inhibitor according to any one of <A1> to <A4> for a polyester-based resin, wherein the polymer (A) has 2 to 8 reactive functional groups on average per molecule of the polymer (A).

<A6> The whitening inhibitor according to any one of <A1> to <A5> for a polyester-based resin, wherein the whitening inhibitor for a polyester-based resin does not contain the polymer (A) having a number average molecular weight of not more than 1000 or contains not more than 4.00% by weight of the polymer (A) having a number average molecular weight of not more than 1000 with respect to 100% by weight of the whitening inhibitor for a polyester-based resin.

<A7> The whitening inhibitor according to any one of <A1> to <A6> for a polyester-based resin, wherein: the whitening inhibitor for a polyester-based resin further includes a polymer (B); a composite consisting of the polymer (A) and the polymer (B) has a core-shell structure in which the polymer (A) forms a core portion and the polymer (B) forms a shell; and in the composite, a weight ratio of the polymer (A) and the polymer (B) (weight of the polymer (A)/weight of the polymer (B)) is 20/80 to 80/20.

<A8> The whitening inhibitor according to <A7> for a polyester-based resin, wherein, in the composite, the number average molecular weight of the polymer (A) is 2,000 to 5,000, and the number average molecular weight of the polymer (B) is 3,000 to 6,000.

<A9> A polyester-based resin composition containing a polyester-based resin and a whitening inhibitor for a polyester-based resin described in any one of <A1> to <A8>.

<A10> The polyester-based resin composition according to <A9> containing 0.1% by weight to 10.0% by weight of the whitening inhibitor for a polyester-based resin with respect to 100% by weight of the polyester-based resin composition.

<A11> The polyester-based resin composition according to <A9> containing 10.0% by weight to 90.0% by weight of the whitening inhibitor for a polyester-based resin with respect to 100% by weight of the polyester-based resin composition, the polyester-based resin composition being a masterbatch.

<A12> The polyester-based resin composition according to any one of <A9> to <A11>, containing a recycled polyester-based resin.

<A13> The polyester-based resin composition according to any one of <A9> to <A12>, wherein the polyester-based resin contains one or more selected from the group consisting of polycarbonate/polyethylene terephthalate, polyethylene terephthalate/glycol-modified polyethylene terephthalate, and polyethylene terephthalate/copolymerized polyethylene terephthalate.

<A14> A molded product obtained by molding a polyester-based resin composition described in any one of <A9> to <A13>.

<A15> A molded product obtained by blow molding of a polyester-based resin composition described in any one of <A9> to <A13>.

One or more embodiments of the present invention may be configured as follows.

<B1> A method for producing a recycled polyester-based resin composition, including the steps of: preparing pellets including a polyester-based resin and a whitening inhibitor for a polyester-based resin by melting and kneading the polyester-based resin and the whitening inhibitor for a polyester-based resin; and carrying out solid state polymerization using the pellets,
the whitening inhibitor for a polyester-based resin containing a polymer (A) obtained by polymerizing a monomer mixture (A) containing
   10% by weight to 60% by weight of an epoxy group-containing monomer (a), and
   40% by weight to 90% by weight of an epoxy group-free monomer (b).

<B2> The method according to <B1>, wherein the monomer mixture (A) further contains 0% by weight to 10% by weight of a vinyl monomer (c) other than the (a) and the (b), the vinyl monomer (c) being copolymerizable with the (a) and the (b).

<B3> The method according to <B1> or <B2>, wherein the epoxy group-free monomer (b) is an epoxy group-free alkyl methacrylate.

<B4> The method according to any one of <B1> to <B3>, wherein the polymer (A) has a number average molecular weight of 2,000 to 6,000.

<B5> The method according to any one of <B1> to <B4>, wherein the polymer (A) has 2 to 15 reactive functional groups on average per molecule of the polymer (A).

<B6> The method according to any one of <B1> to <B5>, wherein the whitening inhibitor for a polyester-based resin does not contain the polymer (A) having a number average molecular weight of not more than 1000 or contains not more than 4.00% by weight of the polymer (A) having a number average molecular weight of not more than 1000 with respect to 100% by weight of the whitening inhibitor for a polyester-based resin.

<B7> The method according to any one of <B1> to <B6>, wherein:
the whitening inhibitor for a polyester-based resin further includes a polymer (B);
a composite consisting of the polymer (A) and the polymer (B) has a core-shell structure in which the polymer (A) forms a core portion and the polymer (B) forms a shell; and
in the composite, a weight ratio of the polymer (A) and the polymer (B) (weight of the polymer (A)/weight of the polymer (B)) is 20/80 to 80/20.

<B8> The method according to <B7>, wherein, in the composite,
the number average molecular weight of the polymer (A) is 2,000 to 5,000, and
the number average molecular weight of the polymer (B) is 3,000 to 6,000.

<B9> The method according to any one of <B1> to <B8>, wherein the whitening inhibitor for a polyester-based resin is contained in an amount of 0.1% by weight to 10.0% by weight with respect to 100% by weight of the recycled polyester-based resin composition.

<B10> The method according to any one of <B1> to <B9>, wherein the recycled polyester-based resin composition has an MFR of 3.7 to 30.0.

<B11> The method according to any one of <B1> to <B10>, wherein the polyester-based resin contains one or more selected from the group consisting of polycarbonate/polyethylene terephthalate, polyethylene terephthalate/glycol-modified polyethylene terephthalate, and polyethylene terephthalate/copolymerized polyethylene terephthalate.

<B12> A method for producing a molded body including the step of molding a recycled polyester-based resin composition obtained by a method described in any one of <B1> to <B11>.

<B13> The method according to <B12>, wherein the step of molding is a blow molding step.

One or more embodiments of the present invention may be configured as follows.

<C1> A molded product obtained by molding a resin composition containing a recycled polyester-based resin,
the molded product having
   a solution haze of not less than 1.50%, and
   a haze of not more than 7.5%,
the solution haze of the molded product being a value measured by performing the following (1) and (2) in order:
   (1) obtaining a solution whose concentration of the resin composition is 0.05 g/mL, by dissolving the resin composition in hexafluoro-2-propanol; and
   (2) measuring the solution haze of the solution of the molded product by use of a haze meter which has been zero-adjusted with hexafluoro-2-propanol; and
the haze of the molded product being a value measured by use of the haze meter.

<C2> The molded product according to <C1>, wherein: the resin composition has a melt flow rate (MFR) of 3.7 g/10 min to 30.0 g/10 min,
where the MFR is a value obtained by measurement under conditions of drying at 130° C. for 8 hours, a temperature of 270° C., and a load of 2.16 kg, in accordance with JIS K 7210-1.

<C3> The molded product according to <C1> or <C2>, having a total light transmittance (TT) of not less than 80%,
where the total light transmittance (TT) of the molded product is a value obtained by use of the haze meter.

<C4> The molded product according to any one of <C1> to <C3>, wherein the recycled polyester-based resin contains one or more selected from the group consisting of recycled [polycarbonate/polyethylene terephthalate], recycled [polyethylene terephthalate/glycol-modified polyethylene terephthalate], and recycled [polyethylene terephthalate/copolymerized polyethylene terephthalate].

<C5> The molded product according to any one of <C1> to <C4>, having a bottle shape.

### EXAMPLES

One or more embodiments of the present invention will be described more specifically with reference to the following Examples and Comparative Examples. However, one or more embodiments of the present invention are not to be construed as being limited thereto, and examples obtained by appropriately combining technical means disclosed in respective Examples are also included in the scope of the present invention.

### [Measurement and Evaluation Methods]

### 1. Particle Size of Polymer or Composite

The particle size of a polymer or composite was measured by Microtrac UPA (manufactured by Nikkiso Co., Ltd.) and obtained by a method in which a volume-average particle size was calculated.

### 2. Polymerization Conversion Rate

The polymerization conversion rate was defined as a ratio (%) of actual solid content to solid content at an ideal conversion rate.

### 3. Number Average Molecular Weight

The number average molecular weights of the polymer (A) and the polymer (B) were calculated by GPC measurement. As a GPC apparatus, an apparatus manufactured by Tosoh Corporation was used. Analysis conditions were as follows:
Column 1 (low-molecular-weight column)
   First column: TSKgel SuperH5000
   Second column: TSKgel SuperH4000
   Third column: TSKgel SuperH3000
   Fourth column: TSKgel SuperH2000
Column 2 (high-molecular-weight column)
   First column: TSKgel SuperHZM-H
   Second column: TSKgel SuperHZM-H
Injection method: Syringe metering
Loop capacity: 100 μL
Preliminary suction amount: 150 μL
Air capacity: 3.5 μL
Automatic cleaning capacity: 1.0 mL
Syringe speed
   Sampling speed: 10 μL/s
   Cleaning speed: 100 μL/s
   Metering speed: 5 μL/s
      Sample flow rate: 0.350 mL/min
      Reference flow rate ratio: 1/1
   Flow rate increase/decrease control: disabled
   Flow rate increase rate: 0.35 mL/min
   Flow rate decrease rate: 0.35 mL/min
Pressure limit
   Column 1
      Sample pressure upper limit: 12.0 MPa
      Sample pressure lower limit: 0.2 MPa
      Reference pressure upper limit: 25.0 MPa
      Reference pressure lower limit: 0.2 MPa
   Column 2
      Sample pressure upper limit: 25.0 MPa
      Sample pressure lower limit: 0.2 MPa
      Reference pressure upper limit: 12.0 MPa
      Reference pressure lower limit: 0.2 MPa
Flow rate
   Column 1
      Sample flow rate: 0.600 mL/min
      Reference flow rate ratio: 1/2
   Column 2
      Sample flow rate: 0.350 mL/min
      Reference flow rate ratio: 1/1
   Flow rate increase/decrease control: disabled
   Flow rate increase rate: 0.35 mL/min/min
   Flow rate decrease rate: 0.35 mL/min/min
Pressure limit
   Column 1
      Sample pressure upper limit: 12.0 MPa
      Sample pressure lower limit: 0.2 MPa
      Reference pressure upper limit: 25.0 MPa
      Reference pressure lower limit: 0.2 MPa
Peak detection conditions
   RI
      Detection sensitivity (front side): 3.000 mV/min
      Detection sensitivity (rear side): 3.000 mV/min
      Base determination value: 1.000 mV/min
      Exclusion area: 10.000 mVs
      Exclusion height: 0.000 mV
      Exclusion half-value width: 0.000 s
   UV/EXT
      Detection sensitivity (front side): 3.000 mV/min
      Detection sensitivity (rear side): 3.000 mV/min
      Base determination value: 1.000 mV/min
      Exclusion area: 10.000 mVs
      Exclusion height: 0.000 mV
      Exclusion half-value width: 0.000 s
         Note that polystyrene was used as a reference material. That is, GPC was performed under the above conditions using polystyrene having a known number average molecular weight. A calibration curve was thus obtained. Thereafter, GPC was performed on samples (polymer (A) and polymer (B)) under the above conditions, and the number average molecular weight of each sample was calculated from the calibration curve.

### 4. Melt Viscosity (IV Value) of Resin Composition (Recycled Polyester-Based Resin Composition or Polyester-Based Resin Composition)

The IV value of the resin composition was measured in accordance with JIS K 7367-5.

### 5. Melt Flow Rates (MFR) of Polyester-Based Resin, Pellets, and Resin Composition (Recycled Polyester-Based Resin Composition or Polyester-Based Resin Composition)

The melt flow rates (MFR) of the polyester-based resin, pellets, and resin composition were measured under conditions of drying at 130° C. for 8 hours, a temperature of 270° C., and a load of 2.16 kg, in accordance with JIS K 7210-1.

### 6. ΔL of Film (Molded Product)

With regard to ΔL of the resin composition of each of Examples, Comparative Examples, and Reference Examples was measured by the following method: (1) pellets of the resin composition were heated to 270° C. by an extruder equipped with a T-die (manufactured by Toyo Seiki Seisaku-sho, Ltd., LABO PLASTOMILL), and thus a film having a thickness of 200 μm was molded; (2) the film thus obtained was punched into a dumbbell shape No. 2 of JIS K 6251, and thus a dumbbell was obtained; (3) the L value of the dumbbell obtained was measured by a colorimeter (manufactured by Nippon Denshoku Industries Co., Ltd., Color Meter ZE6000), and a value obtained was taken as the L value before stretching; (4) the dumbbell was stretched by a factor of 8.5 under conditions of 95° C. and 1000 mm/min by a tensile tester (manufactured by Shimadzu Corp., AG-2000E) in accordance with JIS K 7113; (5) the L value of the dumbbell stretched was measured by the colorimeter, and a value obtained was taken as an L value after stretching; and (6) the L value before stretching was subtracted from the L value after the stretching, and a difference obtained was taken as ΔL of the film (molded product).

### 7. Haze of Solution Obtained by Dissolving Molded Product

(1) The molded product was dissolved in hexafluoro-2-propanol (HFIP), and thus, a resultant solution having a solid content concentration of 0.05 g/mL was obtained; and (2) the haze and total light transmittance of the resultant solution of the molded product were measured by a haze meter (manufactured by Nippon Denshoku Industries Co., Ltd., Haze Meter NDH 4000) which had been zero-adjusted with HFIP.

### 8. L Value of Molded Product

The L value of the molded product was measured by a colorimeter (manufactured by Nippon Denshoku Industries Co., Ltd., Color Meter ZE6000).

### 9. Haze of Molded Product

The haze of the molded product was measured by a haze meter (manufactured by Nippon Denshoku Industries Co., Ltd., NDH 4000).

### 10. Total Light Transmittance (TT) of Molded Product

The total light transmittance (TT) of the molded product was measured by a haze meter (manufactured by Nippon Denshoku Industries Co., Ltd., NDH 4000).

### 11. Buckling Strength

The molded product was used as a sample and measured at a descending speed of 50 mm/min by a compression tester (manufactured by A&D Company, Limited, MCT-1150).

### 12. Wall Thickness of Bottle (Molded Product)

The wall thickness of the bottle (molded product) at locations positioned at respective distances vertically upward from the bottom of the bottle (molded product) was measured by a magnetic thickness gauge (manufactured by Olympus corp., MAGNA MIKE).

### 13. Powder Productivity

On an SUS plate, 2.5 g of powder was spread so as to have a uniform thickness within a range of 2 cm×5 cm. Next, on this SUS plate, a SUS plate of the same type was placed to sandwich the powder. Further, a weight of 5 kg was placed on the top, and heating was carried out in an oven at 70° C. for 2 hours. After natural cooling, the SUS plates were set upright, and the weight percent of the powder that remained attached to the SUS plate was measured. Evaluation criteria were as follows. A larger number means better powder productivity.
2 (good): Less than 20% by weight
1 (acceptable): 20% by weight to 50% by weight
0 (poor): Greater than 50% by weight.

### [Whitening Inhibitor]

### Example A1

### (Production of Polymer (A))

Into a reactor, added were 180 parts by weight of purified water, 1.5 parts by weight of sodium formaldehyde sulfoxylate, 0.0075 parts by weight of EDTA, 0.3 parts by weight of ferrous sulfate heptahydrate, and 0.1 parts by weight of sodium polyoxyethylene lauryl ether phosphate. While a mixture in the reactor was stirred, the temperature in the reactor was raised to 75° C., and the mixture was bubbled with nitrogen for 30 minutes.

Thereafter, a monomer mixture (A) consisting of 35 parts by weight of methyl methacrylate (MMA) which was a component (b), 15 parts by weight of glycidyl methacrylate (GMA) which was a component (a), and 2 parts by weight of n-octyl mercaptan which was a chain transfer agent was added to the reactor over 150 minutes. Further, while the monomer mixture (A) was being added (150 minutes), 0.1 parts by weight of t-butyl hydroperoxide which was a polymerization initiator was added to the reactor over 150 minutes. Furthermore, 80 minutes after addition of the monomer mixture (A), 0.2 parts by weight of sodium polyoxyethylene lauryl ether phosphate which was an anionic surfactant was added all at once to the reactor. Thereafter, a reaction was carried out until the polymerization conversion rate reached 90%, and the reaction was further carried out for 30 minutes from a time point when the polymerization conversion rate reached 90%. As a result of this operation, a polymer (A) was obtained.

### (Production of Polymer (B) (Production of Composite Having Core-Shell Structure))

Next, a monomer mixture (B) consisting of 35 parts by weight of MMA, 15 parts by weight of GMA, and 1.5 parts by weight of n-octyl mercaptan was added to the reactor which contained the polymer (A). While the monomer mixture (B) was being added, 0.1 parts by weight of t-butyl hydroperoxide which was a polymerization initiator was added to the reactor. Furthermore, during addition of the monomer mixture (B), 0.2 parts by weight of sodium polyoxyethylene lauryl ether phosphate which was an anionic surfactant was added to the reactor as needed. Thereafter, a reaction was carried out until the polymerization conversion rate reached 98%, and the reaction was further carried out for 30 minutes from the time point when the polymerization conversion rate reached 98%. As a result of this operation, a polymer (B) was obtained.

Finally, a latex containing a composite of the polymer (A) and the polymer (B) having a particle size of 1100 angstroms was obtained. The final polymerization conversion rate was 98%.

In the composite obtained by the above production method, it can be considered that the polymer (A) forms a core portion and the polymer (B) forms a shell portion. That is, the composite can be considered to have a core-shell structure.

The latex obtained above had two polymers having different number average molecular weights (Mn); the number average molecular weight of the polymer (A) (core component) was 3,000, and the number average molecular weight of the polymer (B) (shell component) was 4,000. The average number of epoxy groups in the polymer (A) (core component) was 5, the average number of epoxy groups in the polymer (B) (shell component) was 6, and the average number of epoxy groups per molecule of the polymer was 5.5.

In order to collect particles of the composite as a powder from the latex, the latex obtained above was quickly added into a 5% calcium chloride aqueous solution while the 5% calcium chloride aqueous solution was being stirred. A mixture obtained was maintained at a temperature of 70° C. by steam. Next, the temperature of the mixture was raised to 85° C. to dehydrate aggregates of the particles of the composite. The aggregates obtained were dried, and thus a powder of the composite was obtained. Thereafter, the powder was sieved with an 18-mesh screen, and the powder that had passed through the 18-mesh screen was obtained as a whitening inhibitor.

### Example A2

A polymer (A) was produced by the same method as in Example A1, except that the monomer mixture (A) in Example A1 was changed to a monomer mixture (A) consisting of 35 parts by weight of MMA, 15 parts by weight of GMA, and 1.5 parts by weight of n-octyl mercaptan. In Example A2, the polymer (B) was not produced. In Example A2, finally, a latex containing the polymer (A) was obtained. Next, particles of the polymer (A) were collected as a powder from the latex by the same method as in Example A1, and the powder thus obtained was used as a whitening inhibitor.

### Example A3

A polymer (A) was produced by the same method as in Example A1. In Example A3, the polymer (B) was not produced. In Example A3, finally, a latex containing the polymer (A) was obtained. Next, particles of the polymer (A) were collected as a powder from the latex by the same method as in Example A1, and the powder thus obtained was used as a whitening inhibitor.

### Example A4

A polymer (A) was produced by the same method as in Example A1, except that the monomer mixture (A) in Example A1 was changed to a monomer mixture (A) consisting of 42.5 parts by weight of MMA, 7.5 parts by weight of GMA, and 2 parts by weight of n-octyl mercaptan. In Example A4, the polymer (B) was not produced. In Example A4, finally, a latex containing the polymer (A) was obtained. Next, particles of the polymer (A) were collected as a powder from the latex by the same method as in Example A1, and the powder thus obtained was used as a whitening inhibitor.

### Comparative Example A1

A latex containing a composite was obtained by performing the same operations as in the method described in (Example A1), except that in (Example A1), (i) in the monomer mixture (A), 35 parts by weight of MMA was changed to 70 parts by weight of styrene (St), and 2 parts by weight of n-octyl mercaptan was changed to 1 part by weight of n-octyl mercaptan, and (ii) in the monomer mixture (B), 40 parts by weight of MMA was changed to 20 parts by weight of St, 10 parts by weight of GMA was changed to 1 part by weight of GMA, and the amount of n-octyl mercaptan used was changed to 0 parts by weight (that is, not used). In the composite in the latex obtained, the number average molecular weight of the polymer (A) was 9,900, the number average molecular weight of the polymer (B) was 120,000, the average number of epoxy groups per molecule of the polymer (A) was 9, and the average number of epoxy groups per molecule of the polymer (B) was unknown. Subsequently, a powder of the composite was obtained from the latex by the same method as in (Example A1) and used as a whitening inhibitor.

Regarding the whitening inhibitors of Examples A1 to A4 and Comparative Example A1, parts by weight of each of the polymer (A) and the polymer (B), the number average molecular weight, the number of reactive functional groups per molecule, and the amount (% by weight) of the component (a) with respect to 100% by weight of the polymer or composite are shown in Table 1. Further, the productivity of the powder was also evaluated. Table 1 shows a result of this evaluation.

TABLE 1

| | | | | | Number of | | | |
|---|---|---|---|---|---|---|---|---|
| | Parts by weight of | | | | reactive functional | | | |
| | each of Polymer (A) | | Number average | | groups per | | | |
| | and polymer (B) | | molecular weight | | molecule | | Component | |
| | Polymer | Polymer | Polymer | Polymer | Polymer | Polymer | (a) | Powder |
| | (A) | (B) | (A) | (B) | (A) | (B) | (wt %) | productivity |
| Example A1 | 50 | 50 | 3000 | 4000 | 5 | 6 | 30 | 2 |
| Example A2 | 100 | — | 4000 | — | 6 | — | 30 | 2 |
| Example A3 | 100 | — | 3000 | — | 5 | — | 30 | 1 |
| Example A4 | 100 | — | 3000 | — | 2.2 | — | 15 | 1 |
| Comparative | 80 | 20 | 9900 | 120000 | 9 | | 12 | 2 |
| Example A1 | | | | | | | | |

### [Resin Composition]

### (Raw Materials)

Polyester-based resin: virgin polyester-based resin (manufactured by Unitika Ltd., MA-8334P). The polyester-based resin was used for production of a resin composition after being subjected to a heat history by the following method: only the virgin polyester-based resin was melted and kneaded at 270° C. by a twin screw extruder (manufactured by Leistritz AG, 35 mm, and L/D=17), and a melted and kneaded product which was extruded through a die was cut.
   Whitening inhibitor: each of the whitening inhibitors of Examples A1 to A4 and Comparative Example A1 was melted and kneaded at 270° C. by a twin screw extruder (manufactured by Toyo Seiki Seisaku-sho, Ltd., LABO PLASTOMILL, Brabender, 19 mm, L/D=20), and a melted and kneaded product which was extruded through a die was cut. As a result of this operation, pellets of each of the whitening inhibitors were obtained. Those obtained pellets of each of the whitening inhibitors were used for production of the resin composition.

### Examples A5 to A8, Comparative Example A2, and Reference Example A

For each of Examples A, Comparative Examples A, and Reference Example A, the polyester-based resin and the whitening inhibitor shown in Table 2 were supplied to a twin screw extruder (manufactured by Leistritz AG, 35 mm, L/D=17) in respective amounts shown in Table 2. A mixture of the polyester-based resin and the whitening inhibitor was melted and kneaded at 270° C. in the extruder, and a melted and kneaded product which was extruded through a die was cut. As a result of this operation, pellets of the resin composition were obtained.

For the pellets of the resin composition obtained in each of Examples A, Comparative Examples A, and Reference Example A, or the pellets of Reference Example A, the melt viscosity (IV value) and MFR were measured by the methods described above. Further, ΔL of a film (molded product) of the resin composition which had been obtained in each of Examples A, Comparative Examples A, and Reference Example A was measured by the method described above. Table 2 shows results of this measurement. In addition, the amount (% by weight) of the component (a) in a case where an entire amount of the resin composition was 100% by weight is shown in the column of “Component (a) (wt %)”.

TABLE 2

| | Composition | | | | | | |
|---|---|---|---|---|---|---|---|
| | Amount of | Whitening inhibitor | | | | | |
| | polyester- | | Blend | | Resin | | |
| | based resin | | amount | | composition | | ΔL of |
| | blended | | (parts | Component | Pellets | | film |
| | (parts by | | by | (a) | IV | | (molded |
| | weight) | Type | weight) | (wt %) | value | MFR | product) |
| Example A5 | 99.2 | Example A1 | 0.8 | 0.24 | 0.83 | 14.2 | 3.9 |
| Example A6 | 99.2 | Example A2 | 0.8 | 0.24 | 0.81 | 17.3 | 4.8 |
| Example A7 | 99.2 | Example A3 | 0.8 | 0.24 | 0.83 | 14.0 | 3.5 |
| Example A8 | 98.4 | Example A4 | 1.6 | 0.24 | 0.83 | 14.6 | 4.0 |
| Comparative | 98 | Comparative | 2 | 0.24 | 0.78 | 22.1 | 11.6 |
| Example A2 | | Example A1 | | | | | |
| Reference | 100 | — | | | 0.72 | 32.8 | — |
| Example A1 | | | | | | | |

### [Molded Product]

### (Raw Materials)

Polyester-based resin: recycled polyester-based resin (rPET FG Resins).

Whitening inhibitor: each of the whitening inhibitors of Example A1 and Comparative Example A1 was melted and kneaded at 270° C. by a twin screw extruder (manufactured by Toyo Seiki Seisaku-sho, Ltd., LABO PLASTOMILL, Brabender, 19 mm, L/D=20), and a melted and kneaded product which was extruded through a die was cut. As a result of this operation, pellets of each of the whitening inhibitors were obtained. Those obtained pellets of each of the whitening inhibitors were used for production of a molded product.

### Examples A9 and A10, Comparative Example A3, and Reference Example A2

### (Production of Resin Composition)

For each of Examples A, Comparative Example A, and Reference Example A, the polyester-based resin and the whitening inhibitor shown in Table 3 were supplied to a twin screw extruder (manufactured by Leistritz AG, 35 mm, L/D=17) in respective amounts shown in Table 3. A mixture of the polyester-based resin and the whitening inhibitor was melted and kneaded at 270° C. in the extruder, and a melted and kneaded product which was extruded through a die was cut. As a result of this operation, pellets of the resin composition were obtained.

### Reference Example A3

A resin composition of Reference Example A3 was obtained by charging recycled polyester-based resin pellets into a batch-type SSP reactor and carrying out solid state polymerization at 230° C.

For the pellets of the resin composition obtained in each of Examples A, Comparative Example A, and Reference Example A2, and the pellets of Reference Example A3, the melt viscosity (IV value) and MFR were measured and evaluated by the methods described above. Furthermore, ΔL of a film (molded product) of the resin composition obtained in each of Examples A, Comparative Example A, and Reference Examples A was measured by the method described above. Table 3 shows results of this measurement.

TABLE 3

| | Composition | | | | | |
|---|---|---|---|---|---|---|
| | Amount of | | | | | |
| | polyester- | Whitening inhibitor | | | | |
| | based | | Blend | Resin | | |
| | resin | | amount | composition | | ΔL of |
| | blended | | (parts | Pellets | | film |
| | (parts by | | by | IV | | (molded |
| | weight) | Type | weight) | value | MFR | product) |
| Example A9 | 99.55 | Example A1 | 0.45 | 0.75 | 27.3 | 3.5 |
| Example | 99.40 | Example A1 | 0.60 | 0.79 | 20.5 | 3.2 |
| A10 | | | | | | |
| Comparative | 98.50 | Comparative | 1.50 | 0.73 | 31.1 | 9.6 |
| Example A3 | | Example A1 | | | | |
| Reference | 100 | — | | 0.72 | 32.0 | 1.4 |
| Example A2 | | | | | | |
| Reference | 100 | — | | 0.8 | 19.2 | 2.0 |
| Example A3 | | | | | | |

### (Production of Bottle (Molded Product))

For the pellets of the resin composition obtained in each of Examples A, Comparative Example A, and Reference Examples A, injection molding was carried out at a molding temperature of 280° C. by an injection molding machine (manufactured by Nissei Plastic Industrial Co., Ltd., FNX-140, screw 045), and thus a preform molded body was obtained. The preform molded body obtained was blow-molded at a surface temperature of approximately 100° C. by a blow molding machine (manufactured by Frontier, Inc., FXT-1R), and thus, a bottle-shaped molded product having an inner volume of 500 ml was obtained.

For the bottle (molded product) obtained in each of Examples A, Comparative Example A, and Reference Examples A, the L value, haze, total light transmittance (TT), wall thickness (distance from the bottom), and buckling strength were measured by the methods described above. Table 4 shows results of this measurement. Further, for the bottle (molded product) obtained in each of Examples A and Comparative Example A, the L value of Reference Example A2 which contained no whitening inhibitor was subtracted from the L value of each of Examples A and Comparative Example A, and a difference (value) thus obtained was defined as ΔL of each of Examples A and Comparative Example A and shown in Table 4. Further, for the bottle (molded product) obtained in each of Examples A and Reference Example A3, the haze of the solution was also measured.

TABLE 4

| | Bottle (molded product) | | | | | | | | | |
|---|---|---|---|---|---|---|---|---|---|---|
| | | | | | Solution | Wall thickness | | | | |
| | | | | | (0.05 g/ml | (distance from | | | | |
| | | | | | HFIP | bottom) | | | | |
| | L | | | | solution) | 160 | 120 | 50 | 10 | Buckling |
| | value | ΔL | Haze | TT | haze | mm | mm | mm | mm | strength |
| Example A9 | 14.2 | 5.15 | 3.24 | 84.9 | 4.85 | 0.35 | 0.21 | 0.25 | 0.29 | 221 |
| Example A10 | 17.3 | 8.23 | 3.6 | 82.8 | 7.03 | 0.31 | 0.23 | 0.26 | 0.29 | 280 |
| Comparative | 25.6 | 16.51 | 7.84 | 79.7 | — | 0.37 | 0.21 | 0.25 | 0.28 | 213 |
| Example A3 | | | | | | | | | | |
| Reference | 9.1 | 0 | 2.21 | 87.1 | — | 0.32 | 0.20 | 0.24 | 0.30 | 205 |
| Example A2 | | | | | | | | | | |
| Reference | — | | | | 0.94 | — | | | | |
| Example A3 | | | | | | | | | | |

### [Recycled Polyester-Based Resin Composition]

### (Raw Materials)

Polyester-based resin: recycled PET bottle flakes, which were crushed products of recycled PET bottles, were used.
   Whitening inhibitor: each of the whitening inhibitors of Example A1 and Comparative Example A1 was melted and kneaded at 270° C. by a twin screw extruder (manufactured by Toyo Seiki Seisaku-sho, Ltd., LABO PLASTOMILL, Brabender, 19 mm, L/D=20), and a melted and kneaded product which was extruded through a die was cut. As a result of this operation, pellets of each of the whitening inhibitors were obtained. Those obtained pellets of each of the whitening inhibitors were used in Examples B and Comparative Examples B.

### Examples B1 to B4 and Comparative Examples B1 to B4

For each of Examples B and Comparative Examples B, the polyester-based resin (recycled PET bottle flakes) and the whitening inhibitor, which were shown in Table 5, were supplied to a twin screw extruder (manufactured by Leistritz AG, 35 mm, L/D=17) in respective amounts shown in Table 5. A mixture of the polyester-based resin and the whitening inhibitor was melted and kneaded at 270° C. in the extruder, and a melted and kneaded product which was extruded through a die was cut. As a result of this operation, pellets of the resin composition were obtained.

TABLE 5

| | | | | | | | | Recycled | | |
|---|---|---|---|---|---|---|---|---|---|---|
| | | | | | | | | polyester-based | | |
| | Recycled PET bottle | | | | | | SSP | resin composition | | |
| | flakes | | Whitening inhibitor | | Pellets | | reaction | after SSP step | | |
| | Blend amount | IV | | Blend amount | IV | | time | IV | | |
| | (wt %) | value | Type | (wt %) | value | MFR | (h) | value | ΔL | MFR |
| Example B1 | 99.85 | 0.76 | Example A1 | 0.15 | 0.72 | 32.1 | 7.0 | 0.84 | 1.5 | 19.2 |
| Example B2 | 99.70 | | | 0.30 | 0.73 | 29.8 | 5.0 | | 1.9 | 19.3 |
| Example B3 | 99.55 | | | 0.45 | 0.75 | 27.3 | 4.0 | | 2.7 | 19.1 |
| Example B4 | 99.40 | | | 0.60 | 0.79 | 20.5 | 1.0 | | 3.1 | 19.0 |
| Comparative | 100.00 | | — | 0.00 | 0.70 | 35.0 | 10.0 | | 1.3 | 19.0 |
| Example B1 | | | | | | | | | | |
| Comparative | 99.00 | | Comparative | 1.00 | 0.72 | 32.5 | 8.0 | | 8.0 | 19.1 |
| Example B2 | | | Example A1 | | | | | | | |
| Comparative | 98.50 | | | 1.50 | 0.73 | 31.1 | 6.0 | | 9.3 | 19.3 |
| Example B3 | | | | | | | | | | |
| Comparative | 98.00 | | | 2.00 | 0.75 | 26.9 | 4.0 | | 12.7 | 19.2 |
| Example B4 | | | | | | | | | | |

With use of the pellets thus obtained, SSP was carried out until the melt viscosity (IV value) reached 0.84 to produce a recycled polyester-based resin composition.

Specifically, the pellets were charged into a rotary reactor, and a reaction was allowed to proceed by stirring while heating. During the heating, temperatures and times shown in Table 6 were used. The heating was carried out through the following steps (i) to (vii) in this order, and after the reaction, the pellets were taken out as they were.

TABLE 6

| | | |
|---|---|---|
| Step | Temperature | Time |

| | | | |
|---|---|---|---|
| (i) | Preheating and drying | 100 | 1.0 |
| (ii) | Preheating and drying | 105 | 4.5 |
| (iii) | Drying and crystallization | 120 | 1.5 |
| (iv) | Drying and crystallization | 150 | 2.0 |
| (v) | Gas removal | 180 | 1.5 |
| (vi) | Gas removal | 210 | 2.0 |
| (vii) | Solid phase polymerization | 230 | 3.0-10.0 |

For the recycled PET bottle flakes, the pellets containing the polyester-based resin and the whitening inhibitor for a polyester-based resin, and the recycled polyester-based resin composition after the step of SSP, which were used in each of Examples B and Comparative Examples B, the melt viscosity (IV value), MFR, and ΔL were measured by the methods described above. Table 5 shows results of these measurements. In addition, Table 5 shows reaction times for the SSP before the IV value reached 0.84.

As shown in Table 5, in a case where the whitening inhibitor obtained in Comparative Example A1 was used instead of the whitening inhibitor obtained in Example A1, it was necessary to blend approximately 1% by weight of the whitening inhibitor in order to increase the IV value of the pellets so that the IV value of the pellets becomes higher than the IV value of the recycled PET bottle flakes. Further, ΔL of the recycled polyester-based resin composition of each of Examples B1 to B3 which were obtained with use of the whitening inhibitor obtained in Example A1 is remarkably smaller than ΔL of the recycled polyester-based resin composition of each of Comparative Examples B2 to B4 which were obtained with use of the whitening inhibitor obtained in Comparative Example A1 instead of the whitening inhibitor obtained in Example A1.

### (Production of Bottle (Molded Product))

For the recycled polyester-based resin composition obtained in Example B1, injection molding was carried out at a molding temperature of 280° C. by an injection molding machine (manufactured by Nissei Plastic Industrial Co., Ltd., FNX-140, screw 045) and thus a preform molded body was obtained. The preform molded body obtained was blow-molded at a surface temperature of approximately 100° C. by a blow molding machine (manufactured by Frontier, Inc., FXT-1R), and a 500 ml bottle (molded product) was thus obtained.

Further, a bottle (molded product) was obtained by the method described above with use of the recycled polyester-based resin composition which had been obtained by the same method as in Example B with use of the whitening inhibitor obtained in Comparative Example A1 instead of the whitening inhibitor obtained in Example A1. The bottle (molded product) which had been obtained from the recycled polyester-based resin composition obtained in Example B1 had a smaller degree of whitening than the bottle (molded product) which had been obtained from the recycled polyester-based resin composition obtained by the same method as in Example B with use of the whitening inhibitor obtained in Comparative Example A1 instead of the whitening inhibitor obtained in Example A1.

One or more embodiments of the present invention make it possible to provide a molded product which contains a recycled polyester-based resin and which has excellent strength and reduced whitening. Further, according to one or more embodiments of the present invention, it is possible to also provide a whitening inhibitor for a polyester-based resin, the whitening inhibitor being capable of providing a polyester-based resin composition which makes it possible to provide a molded product having excellent strength and reduced whitening. Thus, one or more embodiments of the present invention can be suitably used in fields of, for example: automotive applications such as cylinder head covers, engine covers, intake manifolds, radiator tanks, oil pans, accelerator pedals, canisters, fuel tubes, air brake tubes, exhaust gas tubes, hydrogen injectors, ducts, industrial fasteners, and door mirror stays; electric/electronic applications such as coil bobbins, connectors, gears, sockets, switches, electric blanket coated wires, optical fiber cable coating materials, electric tools, and wire binding materials; mechanical applications such as hydraulic/pneumatic connectors/tubes, bearings, covers/housings, bearings, pressure-resistant hoses, and cable ties; building material applications such as curtain rail parts, corners of aluminum sashes, door rollers, handrails, curtain rollers, and door handles; sports/leisure applications such as sports shoe soles, ski/snowboard equipment, reels, and diving snorkels; packaging material/container applications such as shrink packaging films, food packaging films, alcoholic beverage bottles, beverage bottles, and agricultural chemical bottles; and medical applications such as toothbrushes, chair legs and armrests, and sutures.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A molded product obtained by molding a resin composition comprising a recycled polyester-based resin,
the molded product having:
a solution haze of not less than 1.50%, and
a haze of not more than 7.5%,
the solution haze of the molded product being a value measured by performing the following (1) and (2) in order:
(1) obtaining a solution with a concentration of the resin composition of 0.05 g/mL, by dissolving the resin composition in hexafluoro-2-propanol; and
(2) measuring the solution haze of the solution of the molded product with a haze meter which has been zero-adjusted with hexafluoro-2-propanol; and
the haze of the molded product being a value measured with the haze meter.

2. The molded product according to claim 1, wherein:
the resin composition has a melt flow rate (MFR) of from 3.7 g/10 min to 30.0 g/10 min,
where the MFR is a value obtained by measurement under conditions of drying at 130° C. for 8 hours, a temperature of 270° C., and a load of 2.16 kg, in accordance with JIS K 7210-1.

3. The molded product according to claim 1, having a total light transmittance (TT) of not less than 80.0%,
where the total light transmittance (TT) of the molded product is a value measured with the haze meter.

4. The molded product according to claim 1, wherein the recycled polyester-based resin comprises one or more selected from the group consisting of recycled [polycarbonate/polyethylene terephthalate], recycled [polyethylene terephthalate/glycol-modified polyethylene terephthalate], and recycled [polyethylene terephthalate/copolymerized polyethylene terephthalate].

5. The molded product according to claim 1, having a bottle shape.

6. The molded product according to claim 1, wherein:
the resin composition further comprises a whitening inhibitor for a polyester-based resin; and
the whitening inhibitor for a polyester-based resin comprises a polymer (A) obtained by polymerizing a monomer mixture (A) comprising 10% by weight to 60% by weight of an epoxy group-containing monomer (a) and 40% by weight to 90% by weight of an epoxy group-free monomer (b).

7. The molded product according to claim 6, wherein the monomer mixture (A) further comprises 0% by weight to 10% by weight of a vinyl monomer (c) other than the epoxy group-containing monomer (a) and the epoxy group-free monomer (b), the vinyl monomer (c) being copolymerizable with the epoxy group-containing (a) and the epoxy group-free monomer (b).

8. The molded product according to claim 6, wherein the epoxy group-free monomer (b) is an epoxy group-free alkyl methacrylate.

9. The molded product according to claim 6, wherein the polymer (A) has a number average molecular weight of from 2,000 to 6,000.

10. The molded product according to claim 6, wherein the polymer (A) has 2 to 8 reactive functional groups on average per molecule of the polymer (A).

11. The molded product according to claim 6, wherein the whitening inhibitor for a polyester-based resin does not comprise the polymer (A) having a molecular weight of not more than 1000, or comprises not more than 4.00% by weight of the polymer (A) having a molecular weight of not more than 1000 with respect to 100% by weight of the whitening inhibitor for a polyester-based resin.

12. The molded product according to claim 6, wherein:
the whitening inhibitor for a polyester-based resin further comprises a polymer (B);
a composite consisting of the polymer (A) and the polymer (B) has a core-shell structure in which the polymer (A) forms a core portion and the polymer (B) forms a shell; and
in the composite, a weight ratio of the polymer (A) and the polymer (B), which is a weight of the polymer (A) divided by a weight of the polymer (B), is from 20/80 to 80/20.

13. The molded product according to claim 12, wherein, in the composite,
a number average molecular weight of the polymer (A) is from 2,000 to 5,000, and
a number average molecular weight of the polymer (B) is from 3,000 to 6,000.

14. A whitening inhibitor for a polyester-based resin, the whitening inhibitor comprising a polymer (A) obtained by polymerizing a monomer mixture (A) comprising:
10% by weight to 60% by weight of an epoxy group-containing monomer (a), and
40% by weight to 90% by weight of an epoxy group-free monomer (b).

15. A method for producing a molded product, comprising the steps of:
preparing a recycled polyester-based resin composition; and
molding the recycled polyester-based resin composition,
the step of preparing the recycled polyester-based resin composition comprising the steps of:
preparing pellets comprising a polyester-based resin and a whitening inhibitor for a polyester-based resin by melting and kneading the polyester-based resin and the whitening inhibitor for a polyester-based resin; and
carrying out solid state polymerization with the pellets,
the whitening inhibitor for a polyester-based resin comprising a polymer (A) obtained by polymerizing a monomer mixture (A) comprising:
10% by weight to 60% by weight of an epoxy group-containing monomer (a), and
40% by weight to 90% by weight of an epoxy group-free monomer (b).

16. The method according to claim 15, wherein the recycled polyester-based resin composition has an MFR of from 3.7 to 30.0.
